(19) United States
(12) Patent Application Publication
(10) Pub. No.: US 2026/0175675 A1
(43) Pub. Date: Jun. 25, 2026

(54) SEALED FUEL TANK SYSTEM

(71) Applicant: AISAN KOGYO KABUSHIKI KAISHA, Obu-shi (JP)

(72) Inventors: Yuya TANAKA, Hekinan-shi (JP); Yoshikazu MIYABE, Obu-shi (JP); Kensuke NAGAO, Tokai-shi (JP); Daiki KAWAGUCHI, Gifu-shi (JP); Yujiro SUEHIRO, Nagoya-shi (JP)

(73) Assignee: AISAN KOGYO KABUSHIKI KAISHA, Obu-shi (JP)

(21) Appl. No.: 19/410,652

(22) Filed: Dec. 5, 2025

(30) Foreign Application Priority Data
Dec. 24, 2024 (JP) 2024-227807

(51) Int. Cl. B60K 15/03

(52) U.S. Cl. CPC B60K 15/03006; B60K 2015/03026; B60K 2015/0319; B60K 2015/03447

(57) ABSTRACT

A sealed fuel tank system comprising a fuel tank, a canister, a vapor passage, a purge passage, a shut-off valve, a purge valve, a tank pressure detection unit, a lid door operation unit, a lid lock portion, a control unit, and a pre-refueling operation unit. The lid lock portion is configured to lock and unlock the lid door covering a fuel tank opening, and unlocks the lid door when the lid door operation unit is operated by a user and the internal pressure of the fuel tank is lower than or equal to a specified pressure. The pre-refueling operation unit is configured to open the shut-off valve to reduce the internal pressure of the fuel tank to lower than or equal to the specified pressure when operated prior to operation of the lid door operation unit.

### CROSS-REFERENCE TO RELATED APPLICATION

This application claims priority to Japanese patent application serial number 2024-227807 filed Dec. 24, 2024, the content of which is hereby incorporated herein by reference in its entirety for all purposes.

### TECHNICAL FIELD

The present disclosure relates to a sealed fuel tank system in which the fuel tank of a vehicle equipped with an internal combustion engine is sealed.

### BACKGROUND

Vehicles equipped with internal combustion engines are provided with a canister that adsorbs and temporarily stores evaporated fuel generated inside a fuel tank. The canister has adsorbent material inside it. The canister includes an inlet port for receiving evaporated fuel from the fuel tank, an opening connected to the atmosphere, and an outlet port for discharging the stored evaporated fuel into an intake passage of the internal combustion engine. The inlet port is connected to the fuel tank via a vapor passage. The outlet port is connected to the intake passage of the internal combustion engine via a purge passage.

In conventional vehicles, a purge valve is provided in the purge passage, and the opening degree of the purge valve is adjusted according to the operating condition of the internal combustion engine. Evaporated fuel stored in the canister is consumed by the internal combustion engine without being released into the atmosphere. Additionally, conventional vehicles do not have a valve in the vapor passage. Therefore, the vapor passage is always kept open and evaporated fuel frequently flows into the canister. However, in conventional vehicles, the internal combustion engine operates frequently enough to consume the evaporated fuel in the canister, so overflow of evaporated fuel in the canister is rare.

In recent years, the number of PHEVs (plug-in hybrid vehicles) and HEVs (hybrid vehicles) has increased. Compared to internal combustion engine vehicles (vehicles powered solely by internal combustion engine), PHEVs and HEVs have a lower operating frequency of the internal combustion engine. Therefore, the frequency at which evaporated fuel stored in the canister can be consumed by the internal combustion engine is also low. To prevent evaporated fuel from overflowing in the canister (and thus from being released into the atmosphere), a sealed fuel tank system is employed. This system seals the fuel tank by installing a shut-off valve in the vapor passage. The sealed fuel tank system is not limited to PHEVs or HEVs and can also be adopted in internal combustion engine vehicles.

In conventional vehicles without the shut-off valve in the vapor passage, when refueling, the user presses a lid door switch (a switch to open the lid door covering a fuel cap) to open the lid door, expose the fuel cap, remove the fuel cap, and refuel. In conventional vehicles without the shut-off valve in the vapor passage, the pressure inside the fuel tank (hereinafter referred to as “tank internal pressure”) is always approximately atmospheric pressure. Therefore, when the user presses the lid door switch, the lid door opens immediately, and refueling can be started immediately.

However, in vehicles with the sealed fuel tank system equipped with the shut-off valve in the vapor passage, when refueling, even if the user presses the lid door switch, there may be a waiting time of approximately several tens of seconds before the lid door opens. In the sealed fuel tank system, since the fuel tank is sealed by the shut-off valve, the tank internal pressure may become exceedingly high. If the fuel cap is removed while the tank pressure is high, a large amount of evaporated fuel may be released into the atmosphere. To prevent such a situation, in a sealed fuel tank system, the lid door is not unlocked (opened) immediately when the lid door switch is pressed. In the sealed fuel tank system, when the lid door switch is pressed, the shut-off valve is first opened to divert evaporated fuel from the fuel tank to the canister, thereby reducing the tank internal pressure. Then, once the tank internal pressure has decreased to near atmospheric pressure, the lid door is unlocked and opened. This time required to reduce the tank internal pressure can be approximately several tens of seconds. So, there are needs to shorten the waiting time.

For example, a prior art discloses an evaporated fuel treatment device (corresponds to a sealed fuel tank system) that has a position detection unit for acquiring a position of a refueling facility and a current position of the vehicle. When the refueling facility is within a specified distance from the current position of the vehicle, a depressurization process is executed to open the shut-off valve. This reduces the waiting time required for depressurization in the fuel tank when refueling.

In the configuration of the above prior art, the depressurization process for refueling preparation starts automatically as the vehicle approaches the refueling facility. In other words, even if the user has no intention of refueling, the depressurization process for refueling preparation is executed automatically. So, each time the depressurization process is executed, the amount of evaporated fuel stored in the canister increases. For example, in urban areas, there may be many refueling facilities located in succession along major roads. In such a case, even if the user has no intention of refueling, the depressurization process for refueling preparation is executed unnecessarily. This causes reducing the remaining capacity of the canister for adsorbing evaporated fuel, which is undesirable.

Therefore, a sealed tank system is desired that does not execute unnecessary depressurization process for refueling preparation, but instead prioritizes the user's intention to refuel when executing the depressurization process for refueling preparation. This reduces the waiting time during refueling and suppresses the unnecessary reduction of the remaining capacity for adsorbing evaporated fuel in the canister.

### SUMMARY OF THE DISCLOSURES

According to one aspect of the present disclosure, a sealed fuel tank system comprises a fuel tank of a vehicle equipped with an internal combustion engine, a canister configured to adsorb and desorb evaporated fuel generated within the fuel tank, a vapor passage connecting the fuel tank and the canister, a purge passage connecting the canister and an intake passage of the internal combustion engine, a shut-off valve configured to open and close the vapor passage, a purge valve configured to open and close the purge passage, a tank pressure detection unit configured to detect internal pressure of the fuel tank, a lid door operation unit configured to unlock a lid door, a lid lock portion, a control unit implemented by at least one programmed processor and configured to control the purge valve, the shut-off valve, and the lid lock portion, and a pre-refueling operation unit. The lid lock portion is configured to lock and unlock the lid door covering a fuel tank opening, and unlocks the lid door when the lid door operation unit is operated by a user and the internal pressure of the fuel tank is lower than or equal to a specified pressure. The pre-refueling operation unit is configured to open the shut-off valve to reduce the internal pressure of the fuel tank to lower than or equal to the specified pressure when operated prior to operation of the lid door operation unit.

Therefore, when the user intends to refuel, the user can operate the pre-fueling operation unit prior to operating the lid door operation unit at a location slightly before the refueling facility, thereby starting the depressurization of the tank internal pressure. Thus, when the user arrives at the refueling facility, the tank internal pressure has already decreased. When the user arrives at the refueling facility and operates the lid door operation unit, the lid lock unit is immediately unlocked, allowing refueling to start without delay. Therefore, unnecessary automatic depressurization for refueling preparation is avoided, and depressurization for refueling preparation is executed prioritizing the user's intention to refuel. This reduces the waiting time during refueling and suppresses the unnecessary reduction of the residual capacity in the canister for absorbing evaporated fuel.

### BRIEF DESCRIPTION OF DRAWINGS

FIG. 1 shows an overall configuration of a sealed fuel tank system.

FIG. 2 shows a structure around a lid door covering a refueling port and a structure of a lid lock portion.

FIG. 3 is a cross-sectional view taken along a line III-III in FIG. 2.

FIG. 4 is a flowchart illustrating an “Overall processing” executed by a control unit according to a first embodiment.

FIG. 5 is a flowchart illustrating details of a “Processing input of switches/various integration” in FIG. 4.

FIG. 6 is a flowchart illustrating details of a “Notification processing” in FIG. 4.

FIG. 7 is a flowchart illustrating details of a “Processing during general depressurization control” in FIG. 4.

FIG. 8 is a flowchart illustrating details of a “Processing during manual prior depressurization” in FIG. 4.

FIG. 9 is a flowchart illustrating details of a “Processing during cancellation confirmation processing” in FIG. 8.

FIG. 10 is a flowchart illustrating details of a “Processing during automatic prior depressurization” in FIG. 4.

FIG. 11 is a flowchart illustrating details of a “Controlling shut-off valve and lid lock” in FIG. 4.

FIG. 12 is a flowchart illustrating details of a “Controlling general depressurization” in FIG. 11.

FIG. 13 is a flowchart illustrating details of a “Controlling lid door lock” in FIG. 12.

FIG. 14 is a flowchart illustrating details of a “Controlling manual prior depressurization” in FIG. 11.

FIG. 15 shows characteristics of a target shut-off valve opening degree and a target purge adjustment opening degree according to the first embodiment.

FIG. 16 is a flowchart illustrating details of a “Controlling purge valve” of the first embodiment.

FIG. 17 is a flowchart illustrating details of a “Controlling automatic prior depressurization” in FIG. 11.

FIG. 18 is a flowchart illustrating details of a “Controlling engine stop/start” of the first embodiment.

FIG. 19 shows a motion waveform example 1-1 for general depressurization control.

FIG. 20 shows a motion waveform example 1-2 for general depressurization control.

FIG. 21 shows a motion waveform example 2-1 for manual prior depressurization control.

FIG. 22 shows a motion waveform example 2-2 for manual prior depressurization control.

FIG. 23 shows a motion waveform example 3-1 for automatic prior depressurization control.

FIG. 24 is a flowchart illustrating an “Overall processing” executed by a control unit according to a second embodiment.

FIG. 25 is a flowchart illustrating details of a “Processing input of switches/various integration” in FIG. 24.

FIG. 26 is a flowchart illustrating details of a “Processing during general depressurization” in FIG. 24.

FIG. 27 is a flowchart illustrating details of a “Processing during manual prior depressurization” in FIG. 24.

FIG. 28 is a flowchart illustrating details of a “Processing during cancellation confirmation” in FIG. 27.

FIG. 29 is a flowchart illustrating details of a “Controlling shut-off valve and lid lock” in FIG. 24.

FIG. 30 shows characteristics of a target shut-off valve opening degree and a target purge adjustment opening degree according to the second embodiment.

FIG. 31 is a flowchart illustrating details of the “Controlling purge valve” of the second embodiment.

FIG. 32 is a flowchart illustrating details of the “Controlling engine stop/start” of the second embodiment.

### DETAILED DESCRIPTION

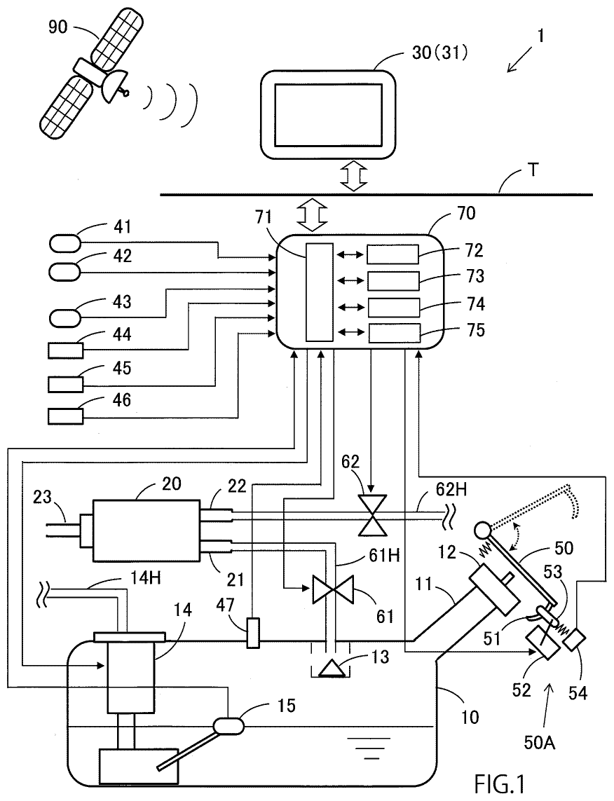

A first embodiment of the present disclosure will be described with reference to figures. The notation “dep.” in figures is an abbreviation for “depressurization.” The notation “o.d.” in figures is an abbreviation for “opening degree.” The notation “←” in flowcharts means “set.” FIG. 1 shows an overall configuration of a sealed fuel tank system 1 mounted on a vehicle. As shown in FIG. 1, the sealed fuel tank system 1 includes a fuel tank 10, a canister 20, a vapor passage 61H, a purge passage 62H, a shut-off valve 61, a purge valve 62, a tank internal pressure detection unit 47, a lid door operation unit 41, a pre-refueling operation unit 42, a lid lock portion 50A, and a control unit 70. The control unit may be implemented by at least one programmed processor whose operation is determined by a predetermined program, gate arrays, and the like. The following description is based on a vehicle (PHEV, HEV, internal combustion engine vehicle) equipped with a gasoline engine (an internal combustion engine) using gasoline as fuel.

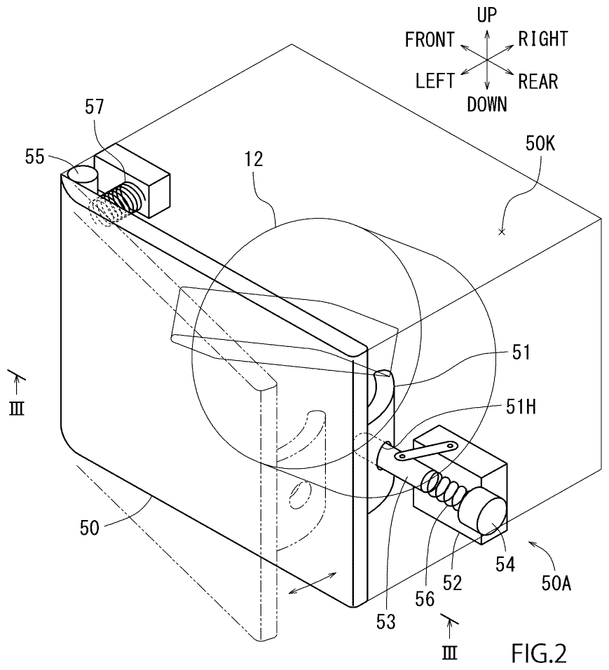

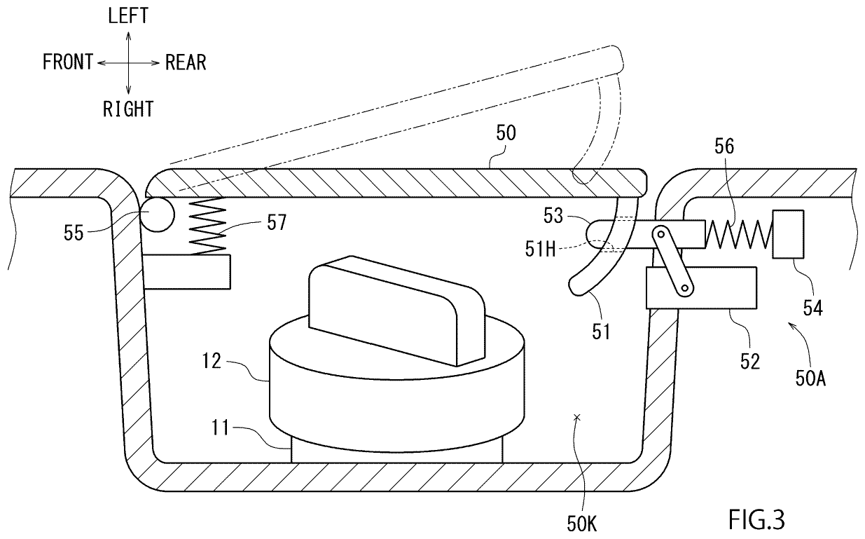

The fuel tank 10 is connected to a fuel supply pipe 11. A fuel cap 12 is attached to the end of the fuel supply pipe 11. As shown in FIGS. 2 and 3, the fuel cap 12 is normally covered by a lid door 50 and is not exposed. When refueling, the user operates the lid door operation unit 41 (for example, a lid door switch) to open the lid door 50, expose the fuel cap 12, remove the fuel cap 12, and refuel.

The fuel tank 10 is connected to the vapor passage 61H that communicates between the inside of the fuel tank 10 and the canister 20. One end of the vapor passage 61H is connected to the fuel tank 10. The other end of the vapor passage 61H is connected to an inlet port 21 of the canister 20. Evaporated fuel (gas) generated inside the fuel tank 10 is directed toward the canister 20. Additionally, a float 13 is provided on the fuel tank 10 side of the vapor passage 61H. The float 13 prevents liquid fuel from entering the vapor passage 61H when the fuel level in the fuel tank 10 approaches the upper limit.

The shut-off valve 61 is provided in the vapor passage 61H. The shut-off valve 61 adjusts the opening degree of the vapor passage 61H based on a control signal from the control unit 70 to open or close the vapor passage 61H, thereby enabling the fuel tank 10 to be sealed. Although not shown in the figure, the shut-off valve 61 is provided with a first bypass passage connecting the fuel tank 10 and the canister 20. The first bypass passage allows the fuel tank 10 and the canister 20 to communicate when the pressure in the fuel tank 10 exceeds the allowable maximum pressure, thereby preventing damage to the fuel tank 10. Additionally, although not shown in the figure, the shut-off valve 61 is provided with a second bypass passage connecting the fuel tank 10 and the canister 20. The second bypass passage allows the fuel tank 10 and the canister 20 to communicate when the pressure in the fuel tank 10 drops below the allowable lower limit pressure, thereby preventing deformation of the fuel tank 10. Therefore, the tank internal pressure is maintained within the range between the allowable lower limit pressure and the allowable upper limit pressure.

A tank internal pressure detection unit 47 is provided inside the fuel tank 10. The tank internal pressure detection unit 47 detects the pressure inside the fuel tank. The tank internal pressure detection unit 47 is, for example, a pressure sensor, and outputs a detection signal corresponding to the tank internal pressure to the control unit 70.

A fuel pump 14 is provided inside the fuel tank 10. The fuel pump 14 is driven by a control signal from the control unit 70 and sucks fuel from the fuel tank 10 and feeds it into a fuel pipe 14H. The fuel pumped into the fuel pipe 14H is supplied to the injector (not shown). The fuel pump 14 has a fuel level detection unit 15 that detects the fuel level in the fuel tank 10. The fuel level detection unit 15 is, for example, a fuel level sensor, and outputs a detection signal corresponding to the fuel level to the control unit 70.

The purge valve 62 is provided in the purge passage 62H. The purge valve 62 adjusts the opening degree of the purge passage 62H based on a control signal from the control unit 70, thereby enabling the purge passage 62H to open or close. The control unit 70 adjusts the opening degree of the purge valve 62 according to the operating condition of the internal combustion engine.

The canister 20 is filled with activated carbon or the like. The canister 20 is connected to the vapor passage 61H and the purge passage 62H. The canister 20 temporarily adsorbs evaporated fuel (vapor) flowing in from the vapor passage 61H and discharges (supplies) the adsorbed evaporated fuel to the intake passage of the internal combustion engine via the purge passage 62H. The purge passage 62H is connected at one end to the outlet port 22 of canister 20 and at the other end to the intake passage (for example, an intake manifold) of the internal combustion engine. The evaporated fuel inside the canister 20 is drawn out by the negative pressure of the internal combustion engine's intake passage when the purge valve 62 is open. The internal combustion engine burns the fuel injected from the injector (not shown) in accordance with the intake volume and the evaporated fuel from the purge passage 62H.

The canister 20 has an atmospheric opening 23 that is open to the atmosphere. For example, when the internal combustion engine is operating and the shut-off valve 61 is fully closed and the purge valve 62 is opened, evaporated fuel in the canister 20 is sucked into the intake passage, and air flows into the atmospheric opening 23. Additionally, for example, when the purge valve 62 is fully closed and the shut-off valve 61 is opened, evaporated fuel from the fuel tank 10 flows into the canister 20, and air that has adsorbed the evaporated fuel flows out through the atmospheric opening 23. Furthermore, for example, when the purge valve 62 is opened and the shut-off valve 61 is opened while the internal combustion engine is operating, the evaporated fuel in the fuel tank 10 is sucked into the intake passage via the vapor passage 61H, the canister 20, and the purge passage 62H.

The lid door 50 covers the fuel cap 12 and is configured so that it cannot be opened except when fuel is supplied, being locked by the lid lock portion 50A. The lid lock portion 50A includes a movable pin 53 capable of locking and unlocking the lid door 50, an unlocking device 52 for operating the movable pin 53, and a pin position detection portion 54 for detecting the position of the movable pin 53. The unlocking device 52 operates the movable pin 53 based on control signals from the control unit 70. The pin position detection unit 54, which is, for example, a proximity sensor, outputs detection signals corresponding to the position of the movable pin 53 (unlocked position, locked position) to the control unit 70. Details of the lid door 50 and the lid lock portion 50A will be described later.

A position information acquisition unit 30 is, for example, a navigation system, and stores a map including various roads and various facilities (including refueling facilities). Based on the map, the position of the vehicle obtained from a GPS satellite 90 is overlaid and displayed on the map. The position information acquisition unit 30 is capable of acquiring the position of the vehicle and the position of refueling facilities (e.g., gas stations). Additionally, the position information acquisition unit 30 is connected to a vehicle's communication line T (e.g., a CAN communication line). Therefore, it can transmit various information, including information regarding the position of the vehicle and of refueling facilities, to various devices (including the control unit 70) connected to the communication line T. The position information acquisition unit 30 can also receive various information from various devices connected to the communication line T.

The position information acquisition unit 30 includes a monitor capable of displaying text information, etc., and a speaker capable of outputting audio information. The monitor and the speaker correspond to a notification unit 31 capable of notifying the user. Additionally, the position information acquisition unit 30 is used not only for displaying a map or outputting notifications but also for outputting various information to the user, receiving instructions from the user for air conditioning devices and audio devices, etc.

The control unit 70 is, for example, an engine control computer including a CPU 71, RAM 72, a ROM 73 (including a Flash-ROM), a timer 74, a non-volatile memory device 75. The control unit 70 receives input signals from detection units such as the lid door operation unit 41, the pre-refueling operation unit 42, an ignition switch 43, a vehicle speed detection unit 44, an atmospheric pressure detection unit 45, an intake air volume detection unit 46, the tank internal pressure detection unit 47, a pin position detection unit 54, and a fuel level detection unit 15. Additionally, the control unit 70 outputs control signals to drive the shut-off valve 61, the purge valve 62, the unlocking device 52, and the fuel pump 14.

The control unit 70 is connected to the communication line T of the vehicle. Therefore, it is capable of transmitting various information to various devices (including the position information acquisition unit 30) connected to the communication line T. Furthermore, the control unit 70 is capable of receiving various information from various devices (including the position information acquisition unit 30) connected to the communication line T.

The lid door operation unit 41 is, for example, the lid door switch provided in conventional vehicles. The lid door operation unit 41 is operated (pressed) by the user to unlock the lid door 50 and open it during refueling. When the shut-off valve 61 is in the fully closed state and the tank internal pressure is high, even if the lid door operation unit 41 is operated, the lid door 50 does not immediately become unlocked. When the lid door operation unit 41 is operated while the tank internal pressure is high, the control unit 70 first opens the shut-off valve 61 to gradually reduce the tank internal pressure. After the tank internal pressure is decreased to a specified pressure near atmospheric pressure, the lid door 50 is unlocked. In other words, when the tank internal pressure is high, there may be a waiting time for depressurization before the lid door 50 is unlocked after the user operates the lid door operating unit 41. This waiting time may be approximately several tens of seconds.

The pre-refueling operation unit 42 is, for example, a newly provided switch such as a pre-refueling switch, which is operated (pressed) by the user prior to operating the lid door operation unit 41. When the user intends to fuel, the user operates the pre-refueling operation unit 42 prior to operating the lid door operation unit 41 while the vehicle is in motion, just before reaching the refueling facility, thereby starting the reduction of tank internal pressure. Upon arrival at the refueling facility, the tank internal pressure has sufficiently decreased, so when the user operates the lid door operation unit 41, the lid door 50 can be unlocked and opened immediately without any waiting time.

The pre-refueling operation unit 42 may be shared with the lid door operation unit 41. For example, the control unit 70 may determine that the lid door operation unit 41 has been operated if it is pressed and held, and determine that the pre-refueling operation unit 42 has been operated if it is pressed briefly. However, in the following description, the lid door operation unit 41 and the pre-refueling operation unit 42 are described as being provided as separate switches.

The ignition switch 43 is a switch that the user operates (presses) when starting and finishing driving the vehicle. When starting to drive, the user presses the ignition switch to turn the ignition ON and drives the vehicle. When finishing driving, the user presses the ignition switch to turn the ignition OFF. The control unit 70 can detect whether the ignition is ON or OFF.

The vehicle speed detection unit 44 is, for example, a vehicle speed sensor, and outputs a detection signal corresponding to the vehicle speed to the control unit 70.

The atmospheric pressure detection unit 45 is, for example, an atmospheric pressure sensor, and outputs a detection signal corresponding to atmospheric pressure to the control unit 70.

The intake air volume detection unit 46 is, for example, an intake air volume sensor. The intake air volume detection unit 46 is provided in the intake passage of the internal combustion engine, and outputs a detection signal corresponding to the intake air volume to the control unit 70.

FIG. 2 is a perspective view showing a structure around the lid door 50 covering a refueling port provided on the vehicle. FIG. 3 is a cross-sectional view taken along a line III-III in FIG. 2. In FIGS. 2 and 3, front, rear, right, left, up, and down indicate the respective directions relative to the vehicle on which the lid door 50 is provided.

The lid door 50 is provided on the side of the vehicle and covers the fuel cap 12. The fuel cap 12 is provided within a cap surrounding space 50K. The lid door 50 is rotatable at a hinge 55 and is biased toward the outside of the vehicle by an elastic member 57 such as a spring. The lid door 50 has a locking portion 51 extending in a curved manner toward the interior of the vehicle at the edge opposite the hinge 55. The locking portion 51 has a locking hole 51H.

The lid lock portion 50A is provided in the vicinity of the locking portion 51 within the cap surrounding space 50K. The lid lock portion 50A has a movable pin 53, the unlocking device 52, a pin position detection unit 54, and an elastic member 56.

When the unlocking device 52 is energized by a control signal from the control unit 70, it moves the movable pin 53 toward the pin position detection unit 54 with a force greater than the elastic force of the elastic member 56. When the lid door 50 is closed and the unlocking device 52 is energized, the unlocking device 52 pulls out the movable pin 53 inserted into the locking hole 51H, thereby unlocking the lid door 50. The unlocked lid door 50 rotates outward toward the exterior of the vehicle due to the elastic member 57, and the lid door 50 is opened.

When the energization from the control unit 70 to the unlocking device 52 is stopped, the movable pin 53 is pushed out in the opposite direction of the pin position detection unit 54 by the elastic force of the elastic member 56. When the lid door 50 is closed, the pushed-out movable pin 53 is inserted into the locking hole 51H, thereby locking the lid door 50 in the locked state.

The movable pin 53 is biased in the direction toward the locking hole 51H by the elastic member 56. As described above, when the unlocking device 52 is energized, the movable pin 53 is pulled toward the pin position detection unit 54. When the energization of the unlocking device 52 is stopped, the movable pin 53 is pushed away from the pin position detection unit 54 by the elastic member 56. Furthermore, as the user gradually closes the lid door 50 from its opened state, the movable pin 53 is pushed by the curved portion of the locking portion 51 toward the pin position detection unit 54. When the lid door 50 is fully closed, the tip of the movable pin 53 aligns with the locking hole 51H. The movable pin 53 is then pushed out by the elastic member 56 and inserted into the locking hole 51H, thereby the lid door 50 will be in the locked position.

The pin position detection unit 54 is a proximity sensor that turns ON when the movable pin 53 is in close proximity and OFF otherwise. For example, the pin position detection unit 54 outputs an ON signal to the control unit 70 when the movable pin 53 is pulled toward the pin position detection unit 54 by the energized unlocking device 52. Additionally, the pin position detection unit 54 outputs an ON signal to the control unit 70 when the movable pin 53 temporarily approaches the pin position detection unit 54 when the user closes the open lid door 50.

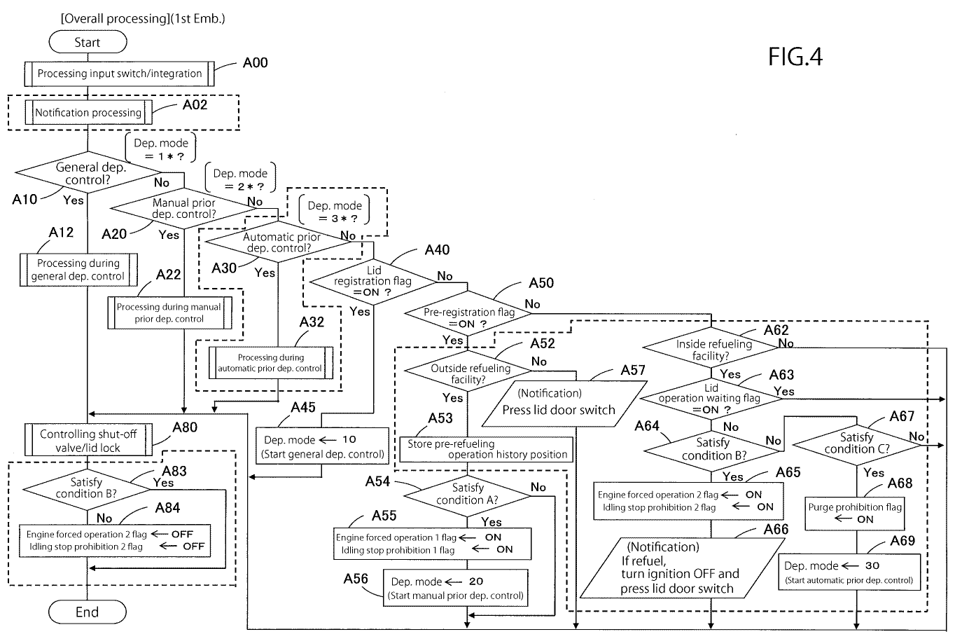

Referring to FIGS. 4 to 23, a first embodiment of the present disclosure will be described. FIG. 4 shows the overall processing. First, the depressurization control process, in which the control unit 70 controls the shut-off valve 61, etc. to reduce the tank internal pressure in response to operation of the pre-refueling operation unit 42 (the pre-refueling switch), the lid door operation unit 41 (the lid door switch), etc. by the user, will be described.

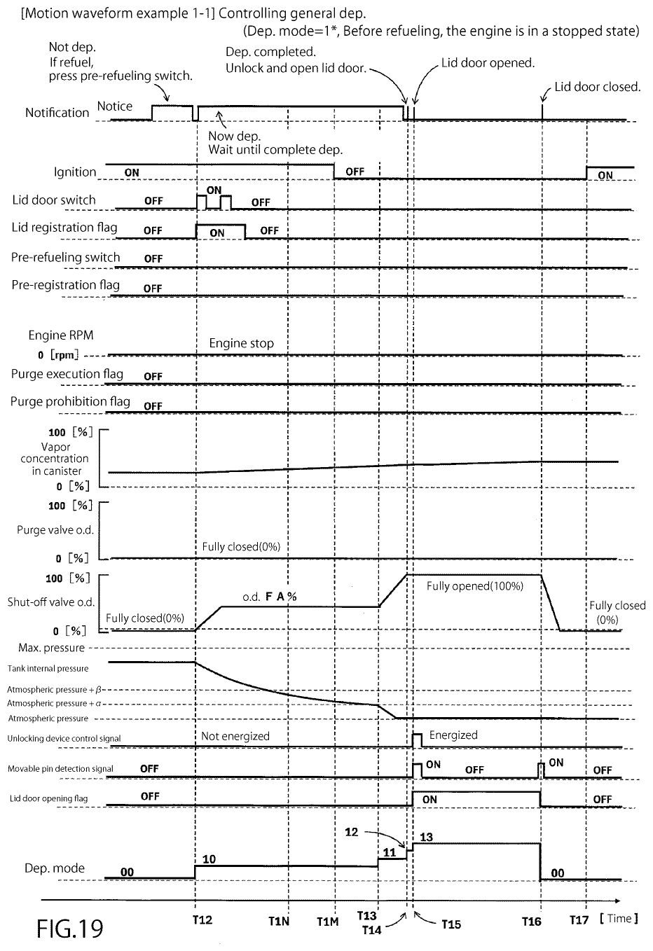

The depressurization control executed by the control unit 70 to open the shut-off valve 61 and reduce the tank internal pressure includes three types of depressurization control: (A) general depressurization control, (B) manual prior depressurization control, and (C) automatic prior depressurization control. As shown in the “Depressurization mode” at the bottom row of the [Motion waveform example] in FIGS. 19 to 23, the control unit 70 sets the value of the “Depressurization mode” according to the execution status of each depressurization control.

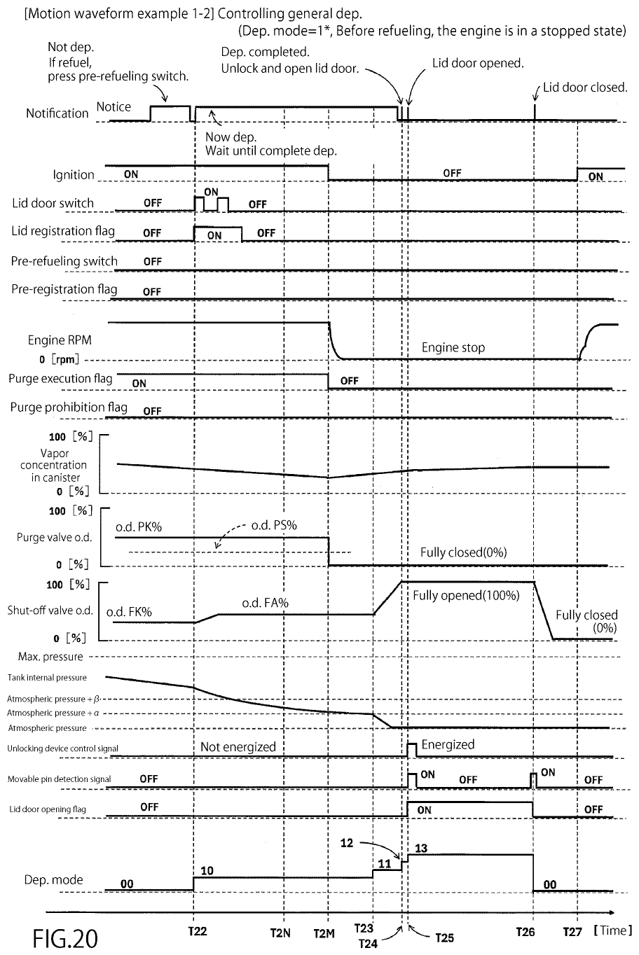

(A) “General depressurization control” is a depressurization control that starts when the user operates the lid door operation unit 41 (the lid door switch) from a state where both the lid door operation unit 41 and the pre-refueling operation unit 42 (the pre-refueling switch) are not operated, as shown in the [Motion waveform example] in FIGS. 19 and 20. When the control unit 70 determines that the general depressurization control has been completed (i.e., the depressurization mode is “12”), unlocks and opens the lid door 50. During the execution of the general depressurization control, the “Depressurization mode” is set to one of 10, 11, 12, or 13, as shown in the bottom row of the [Motion waveform example] in FIGS. 19 and 20.

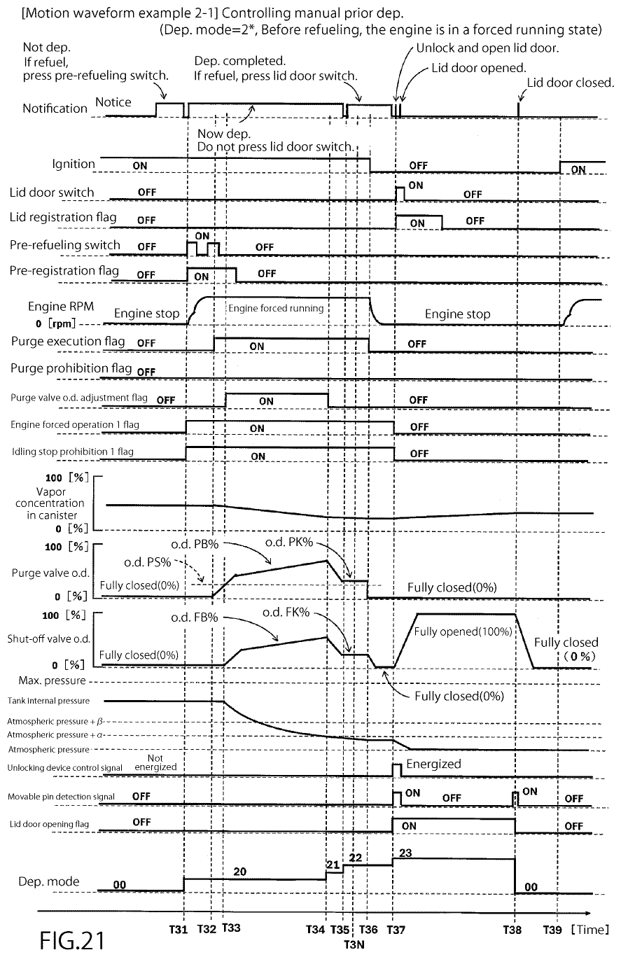

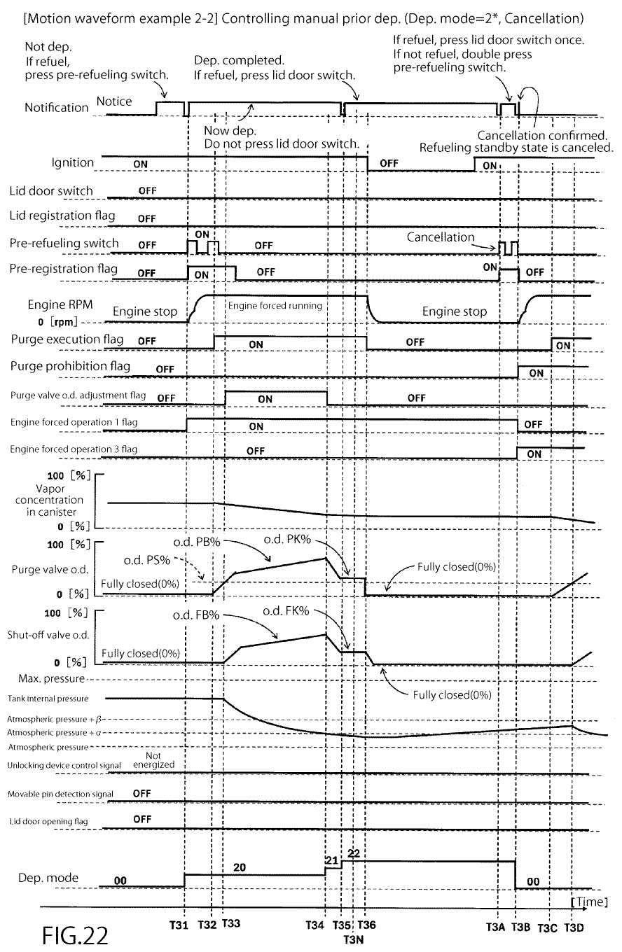

(B) “Manual prior depressurization control” is a depressurization control that starts when the user operates the pre-refueling operation unit 42 (the pre-refueling switch) from a state where both the lid door operation unit 41 (the lid door switch) and the pre-refueling operation unit 42 are not operated, as shown in the [Motion waveform example] in FIGS. 21 and 22. The control unit 70 waits for operation of the lid door operation unit 41 after depressurization is completed by the manual prior depressurization control (i.e., after the depressurization mode becomes “22”), and unlocks and opens the lid door 50 when the lid door operation unit 41 is operated. During the execution of the manual prior depressurization control, the “Depressurization mode” is set to one of 20, 21, 22, or 23, as shown in the bottom row of the [Motion waveform example] in FIGS. 21 and 22.

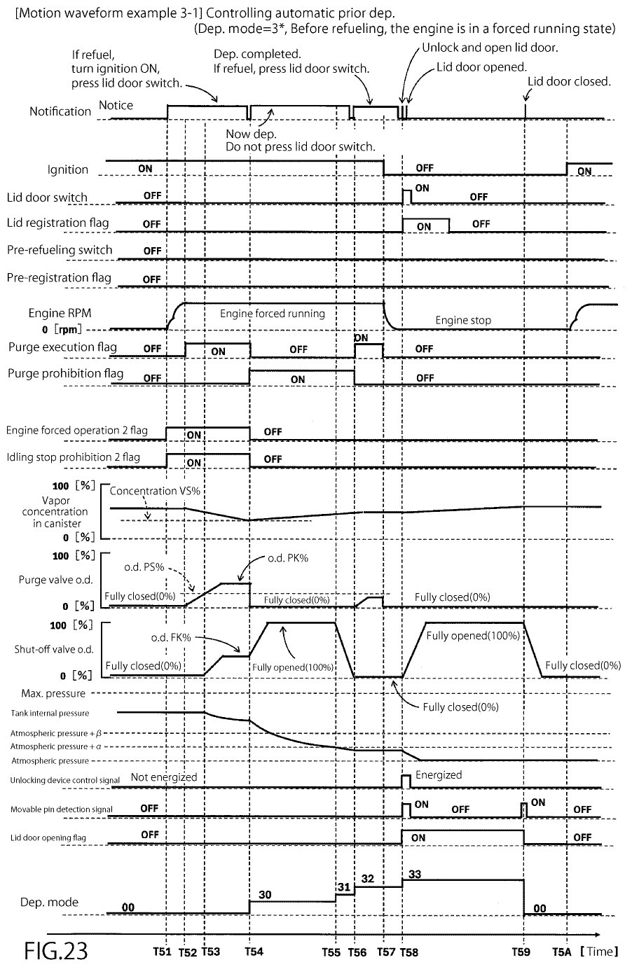

(c) “Automatic prior depressurization control” is a depressurization control that automatically starts when the vehicle enters the refueling facility from a state where both the lid door operation unit 41 (the lid door switch) and the pre-refueling operation unit 42 (the pre-refueling switch) are not operated, as shown in the [Motion waveform example] in FIG. 23. The control unit 70 waits for operation of the lid door operation unit 41 after the depressurization is completed by the automatic prior depressurization control (i.e., after the depressurization mode becomes “32”), and unlocks and opens the lid door 50 when the lid door operation unit 41 is operated. During the execution of the automatic prior depressurization control, the “Depressurization mode” is set to one of 30, 31, 32, or 33, as shown in the bottom row of the [Motion waveform example] in FIG. 23.

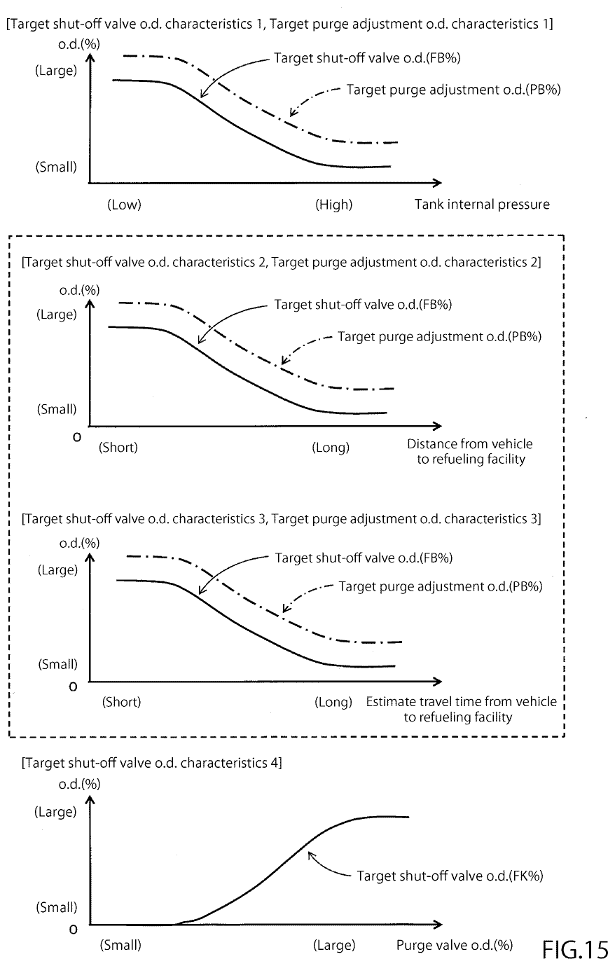

FIG. 4 shows the processing steps of the [Overall processing] by the control unit 70 according to the first embodiment. In the first embodiment, an example is described in which the position of the vehicle and the position of the refueling facility obtained by the position information acquisition unit 30 are used for the depressurization control of the tank internal pressure. In a second embodiment described later, an example is described in which the position of the vehicle and the position of the refueling facility are not used for depressurization control of the tank pressure. In the flowcharts in FIGS. 4 to 18, the processes enclosed by dotted lines and the characteristics enclosed by dotted lines (FIG. 15) are processes executed, and characteristics used in the first embodiment, but are omitted in the second embodiment described later.

The control unit 70 boots the process shown in FIG. 4 at specified time intervals (e.g., intervals of several tens of milliseconds to several hundred of milliseconds) regardless of the ON/OFF state of the ignition switch, and then processing is advanced to Step A00.

At Step A00, the control unit 70 executes [Processing input of switches/various integration], then processing is advanced to Step A02. Details of [Processing input of switches/various integration] will be described later.

At Step A02, the control unit 70 executes [Notification processing], then processing is advanced to Step A10. Details of [Notification processing] will be described later.

At Step A10, the control unit 70 determines whether general depressurization control is being executed. If general depressurization control is being executed (Yes), processing is advanced to Step A12; otherwise (No), processing is advanced to Step A20. When general depressurization control is being executed, the “Depressurization mode” in the bottom row of the motion waveform examples of FIGS. 19 and 20 is 10, 11, 12, or 13. Therefore, the control unit 70 determines that general depressurization control is being executed when the depressurization mode is “1*.”

If processing is advanced to Step A12, the control unit 70 executes the “Processing during general depressurization control”, then processing is advanced to Step A80. Details of the “Processing during general depressurization control” will be described later.

If processing is advanced to Step A20, the control unit 70 determines whether manual prior depressurization control is being executed. If manual prior depressurization control is being executed (Yes), processing is advanced to Step A22; otherwise (No), processing is advanced to Step A30. If manual prior depressurization control is being executed, the “Depressurization mode” in the bottom row of the motion waveform examples of FIGS. 21 and 22 is 20, 21, 22, or 23. Therefore, the control unit 70 determines that manual prior depressurization control is being executed when the depressurization mode is “2*.”

If processing is advanced to Step A22, the control unit 70 executes the “Processing during manual prior depressurization control”, then processing is advanced to Step A80. Details of the “Processing during manual prior depressurization control” will be described later.

If processing is advanced to Step A30, the control unit 70 determines whether the automatic prior depressurization control is being executed. If the automatic prior depressurization control is being executed (Yes), processing is advanced to Step A32; otherwise (No), processing is advanced to Step A40. When the automatic prior depressurization control is being executed, the “Depressurization mode” in the bottom row of the motion waveform example of FIG. 23 is 30, 31, 32, or 33. Therefore, the control unit 70 determines that automatic prior depressurization control is being executed when the depressurization mode is “3*.”

If processing is advanced to Step A32, the control unit 70 executes the “processing during controlling the automatic prior depressurization”, then processing is advanced to Step A80. Details of the “processing during controlling the automatic prior depressurization” will be described later.

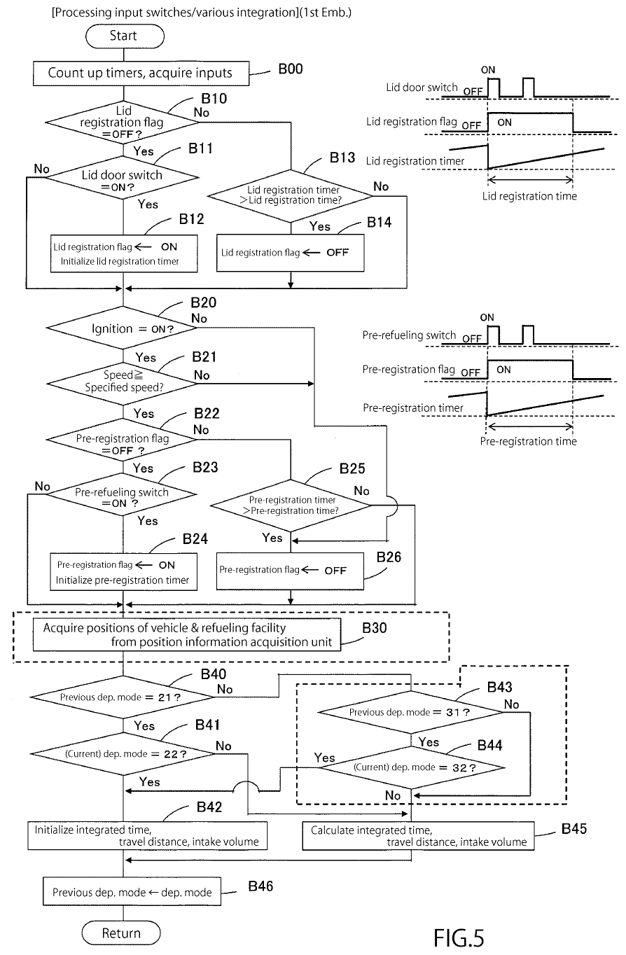

If processing is advanced to Step A40, the control unit 70 determines whether a lid registration flag is ON. If the lid registration flag is ON (Yes), processing is advanced to Step A45; otherwise (No), processing is advanced to Step A50. If the process is advanced to Step A40, the depressurization mode is “00,” and no depressurization control is being executed. Note that the lid registration flag is a flag that is set to ON for a lid registration time (e.g., a few seconds) when the lid door operation unit 41 (the lid door switch) is operated, as shown in FIG. 5.

If processing is advanced to Step A45, the control unit 70 sets the depressurization mode to “10” and starts general depressurization control (see, time T12 in FIG. 19 and time T22 in FIG. 20), then processing is advanced to Step A80. If processing is advanced to Step A40, since the depressurization mode is “00,” the general depressurization control is started if the lid registration flag is ON.

If processing is advanced to Step A50, the control unit 70 determines whether a pre-registration flag is ON. If the pre-registration flag is ON (Yes), processing is advanced to Step A52; otherwise (No), processing is advanced to Step A62. As shown in FIG. 5, the pre-registration flag is a flag that is set to ON for a pre-registration time (e.g., a few seconds) when the pre-refueling operation unit 42 (the pre-refueling switch) is operated.

If processing is advanced to Step A52, the control unit 70 determines whether the vehicle is outside the refueling facility. The control unit 70 determines whether the vehicle is outside the refueling facility based on the vehicle's position on the map or on the Earth, the position of the refueling facility, and the facility boundaries, as obtained by [Processing input of switches/various integration] at Step A00. If the control unit 70 determines that the vehicle is outside the refueling facility (Yes), processing is advanced to Step A53; otherwise (No), processing is advanced to Step A57.

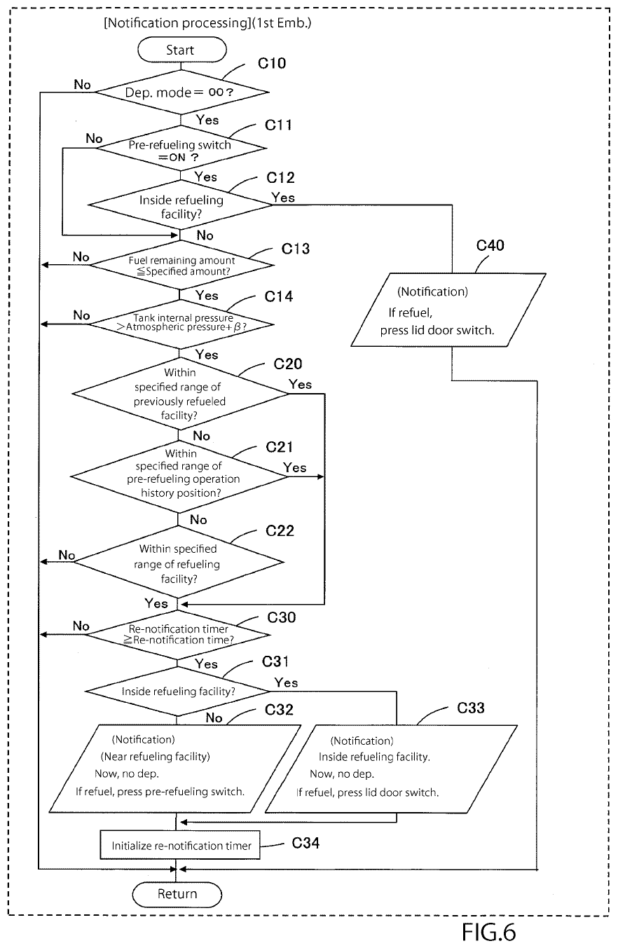

If processing is advanced to Step A53, the control unit 70 stores the position of the vehicle at the time the pre-refueling operation unit 42 was operated prior to the operation of the lid door operation unit 41 on the map or on the Earth as the “pre-refueling operation history position.”, then processing is advanced to Step A54. The “pre-refueling operation history position” is used in the “Notification processing” in FIG. 6 described later.

At Step A54, the control unit 70 determines whether an execution condition A is satisfied. The execution condition A is, for example, “the tank internal pressure is greater than (atmospheric pressure+β)” and “fuel remaining amount is below a specified remaining amount.” The values of β and the specified remaining amount are set to appropriate values confirmed through experiments using actual vehicles or simulations. For example, the value of “β” is set to approximately 5 kPa. If the execution condition A is satisfied (Yes), processing is advanced to Step A55; otherwise (No), processing is advanced to Step A80.

If processing is advanced Step A55, the control unit 70 sets an engine forced operation 1 flag to ON and sets an idling stop prohibition 1 flag to ON (see time T31 in FIG. 21 and FIG. 22), then processing is advanced to Step A56. The engine forced operation 1 flag is a flag that enables the engine to be forced to operate when the ignition is ON and the engine is in a stopped state. The idling stop prohibition 1 flag is a flag that prohibits the operation of the idling stop function. In other words, after the processing of Step A55, if the ignition is ON, the engine is in an operating state (see time T31 in FIGS. 21 and 22).

If processing is advanced to Step A56, the control unit 70 sets the depressurization mode to “20” and starts manual prior depressurization control (see time T31 in FIGS. 21 and 22), then processing is advanced to Step A80. If the processing is advanced to Step A50, since the depressurization mode is “00,” if the pre-registration flag is ON, the vehicle is outside the refueling facility, and the execution condition A is satisfied, the manual prior depressurization control is started.

If processing is advanced to Step A57, the control unit 70 outputs a notification such as “Please press the lid door switch” using the monitor or speaker of the notification unit 31 in the form of text or voice information, then processing is advanced to Step A80. If the vehicle is already inside the refueling facility, the control unit 70 prompts general depressurization control by the lid door operation unit 41 (the lid door switch).

If processing is advanced to Step A62, the control unit 70 determines whether the vehicle is inside the refueling facility. If the control unit 70 determines that the vehicle is inside the refueling facility (Yes), processing is advanced to Step A63; otherwise (No), processing is advanced to Step A80.

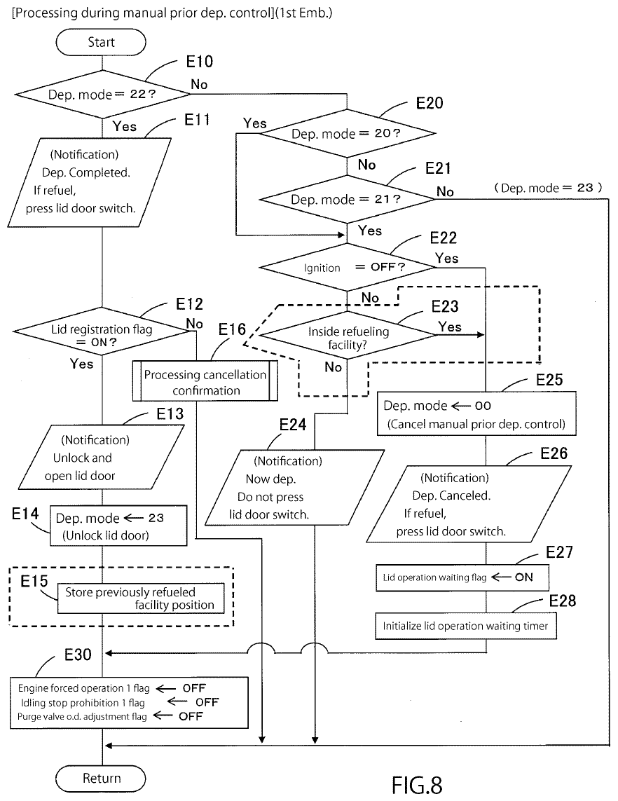

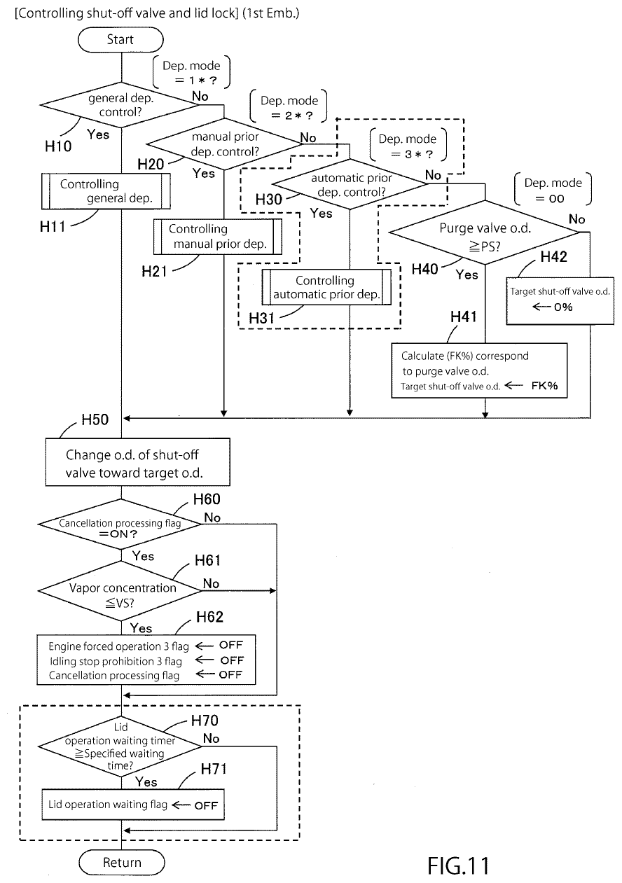

If processing is advanced to Step A63, the control unit 70 determines whether a lid operation waiting flag is ON. The lid operation waiting flag is a flag that is set to ON at Step E27 in FIG. 8 and set to OFF at Step H71 in FIG. 11. If the lid operation waiting flag is ON (Yes), processing is advanced to Step A80; otherwise (No), processing is advanced to Step A64.

If processing is advanced to Step A64, the control unit 70 determines whether an execution condition B is satisfied. The execution condition B is, for example, “vapor concentration in the canister is greater than a specified vapor concentration (VS %)” and “ignition ON.” The vapor concentration is calculated based on existing purge control using parameters such as intake air volume, internal combustion engine speed, fuel injection amount, purge valve opening, and air-fuel ratio. The specified vapor concentration (VS %) is set to an appropriate value confirmed through experiments using actual vehicles or simulations. If the execution condition B is satisfied (Yes), processing is advanced to Step A65; otherwise (No), processing is advanced to Step A67.

If processing is advanced to Step A65, the control unit 70 sets an engine forced operation 2 flag to ON and sets an idling stop prohibition 2 flag to ON (see time T51 in FIG. 23), then processing is advanced to Step A66. The engine forced operation 2 flag is a flag that enables the engine to be forced to operate when the ignition is ON and the engine is in a stopped state. The idling stop prohibition 2 flag is a flag that prohibits the operation of the idling stop function. In other words, after the processing of Step A65, if the ignition is ON, the engine is in an operating state (see time T51 in FIG. 23).

At Step A66, the control unit 70 outputs a notification such as “If refueling, turn the ignition OFF and press the lid door switch” from the notification unit 31, then processing is advanced to Step A80. Since the execution condition B is satisfied and the vapor concentration is high, before starting automatic prior depressurization control, the engine starts and purge control is executed to reduce the vapor concentration (see time T52 to time T54 in FIG. 23).

If processing is advanced to Step A67, the control unit 70 determines whether an execution condition C is satisfied. The execution condition C is, for example, that the “tank internal pressure is greater than (atmospheric pressure+β)” and the “fuel remaining amount is less than or equal to the specified remaining amount.” The values of β and the specified remaining amount are set to appropriate values confirmed through experiments using actual vehicles or simulations. If the execution condition C is satisfied (Yes), processing is advanced to Step A68; otherwise (No), processing is advanced to Step A80.

If processing is advanced to Step A68, the control unit 70 sets a purge prohibition flag to ON (see time T54 in FIG. 23), then processing is advanced to Step A69. The purge prohibition flag is a flag that prohibits purge control while the engine is running. The automatic prior depressurization control is executed when the vehicle enters the refueling facility with neither the lid door operation unit 41 nor the pre-refueling operation unit 42 being operated opens the shut-off valve 61 at a relatively large opening to reduce the tank internal pressure more quickly (see time T54 to time T55 in FIG. 23). Therefore, if purge control is executed, the air-fuel ratio of the engine will fluctuate greatly, so purge control is prohibited (by closing the purge valve).

At Step A69, the control unit 70 sets the depressurization mode to “30” and starts the automatic prior depressurization control (see time T54 in FIG. 23), then processing is advanced to Step A80. If the processing is advanced to Step A50, the depressurization mode is “00.” Therefore, if the lid registration flag is OFF, the pre-registration flag is OFF, the vehicle is inside the refueling facility, the lid operation wait flag is OFF, execution condition B is not satisfied, and execution condition C is satisfied, automatic prior depressurization control is started.

If processing is advanced to Step A80, the control unit 70 executes [Controlling shut-off valve and lid lock], then processing is advanced to Step A83. Details of [Controlling shut-off valve and lid lock] are described later.

At Step A83, the control unit 70 determines whether the execution condition B is satisfied. The Execution condition B is the same as the execution condition B at Step A64 (i.e., “vapor concentration in the canister is greater than a specified vapor concentration (VS %)” and “ignition ON”). If the execution condition B is satisfied (Yes), the control unit 70 terminates the processing shown in FIG. 4; otherwise (No), processing is advanced to Step A84.

If processing is advanced to Step A84, the control unit 70 sets the engine forced operation 2 flag to OFF and sets the idling stop prohibition 2 flag to OFF (see time T54 in FIG. 23), then the control unit 70 terminates the processing shown in FIG. 4.

FIG. 5 is a flowchart illustrating an example of the details of the [Processing input of switches/various integration] at Step A00 in FIG. 4. When the control unit 70 executes the [Processing input of switches/various integration] at Step A00 in FIG. 4, processing is advanced to the [Processing input of switches/various integration] at Step B00 in FIG. 5.

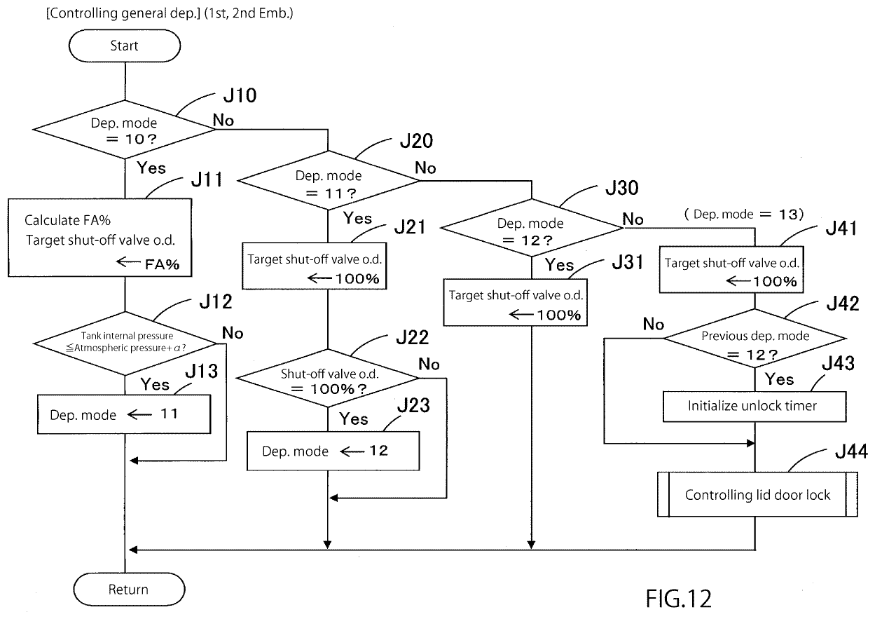

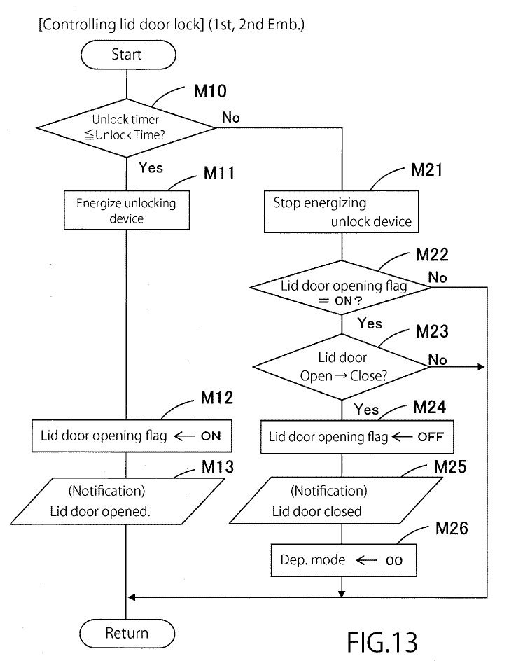

At Step B00, the control unit 70 counts up each timer, acquires various inputs, then processing is advanced to Step B10. “Timers” refers to timers such as the “lid registration timer, pre-registration timer” in FIG. 5, the “re-notification timer” in FIG. 6, the “lid operation waiting timer” in FIG. 8, and the “unlocking timer” in FIGS. 12 and 13, which are named with the suffix “*timer.” Each timer is set to an appropriate initial value when the ignition is switched from OFF to ON. “Various inputs” include, for example, atmospheric pressure (obtained by the atmospheric pressure detection unit 45), fuel level (obtained by the fuel level detection unit 15), tank internal pressure (obtained by the tank internal pressure detection unit 47), vehicle speed (obtained by the vehicle speed detection unit 44), intake air volume (obtained by the intake air volume detection unit 46), vapor concentration (obtained by the existing purge control), and so on.

At Step B10, the control unit 70 determines whether the lid registration flag is OFF. As shown in FIG. 5, the lid registration flag is a flag that is set to ON for a lid registration time (e.g., a few seconds) when the lid door operation unit 41 is operated (when the lid door switch is pressed). If the lid registration flag is OFF (Yes), processing is advanced to Step B11; otherwise (No), processing is advanced to Step B13.

If processing is advanced to Step B11, the control unit 70 determines whether the lid door switch is ON (whether the lid door operation unit 41 is pressed). If the lid door switch is ON (Yes), processing is advanced to Step B12; otherwise (No), processing is advanced to Step B20.

If processing is advanced to Step B12, the control unit 70 sets the lid registration flag to ON, initializes (resets to zero) the lid registration timer, and processing is advanced to Step B20.

If processing is advanced to Step B13, the control unit 70 determines whether the lid registration timer has exceeded the lid registration time. If the lid registration timer has exceeded the lid registration time (Yes), processing is advanced to Step B14; otherwise (No), processing is advanced to Step B20.

If processing is advanced to Step B14, the control unit 70 sets the lid registration flag to OFF, then processing is advanced to Step B20.

If processing is advanced to Step B20, the control unit 70 determines whether the ignition is ON. If the ignition is ON (Yes), processing is advanced to Step B21; otherwise (No), processing is advanced to Step B26.

If processing is advanced to Step B21, the control unit 70 determines whether the vehicle speed is greater than or equal to a specified vehicle speed. The specified vehicle speed is, for example, approximately 4 km/h. If the vehicle speed is greater than or equal to the specified vehicle speed (Yes), processing is advanced to Step B22; otherwise (No), processing is advanced to Step B26.

If processing is advanced to Step B22, the control unit 70 determines whether a pre-registration flag is OFF. As shown in FIG. 5, the pre-registration flag is a flag that is set to ON for a pre-registration time (e.g., a few seconds) when the pre-refueling operation unit 42 is operated (when the pre-refueling operation switch is pressed). If the pre-registration flag is OFF (Yes), processing is advanced to Step B23; otherwise (No), processing is advanced to Step B25.

If processing is advanced to Step B23, the control unit 70 determines whether the pre-refueling switch is ON. If the pre-refueling switch is ON (Yes), processing is advanced to Step B24; otherwise (No), processing is advanced to Step B30.

If processing is advanced to Step B24, the control unit 70 sets the pre-registration flag to ON, initializes (resets to zero) the pre-registration timer, then processing is advanced to Step B30.

If processing is advanced to Step B25, the control unit 70 determines whether the pre-registration timer has exceeded the pre-registration time. If the pre-registration timer has exceeded the pre-registration time (Yes), processing is advanced to Step B26; otherwise (No), processing is advanced to Step B30.

If processing is advanced to Step B26, the control unit 70 sets the pre-registration flag to OFF, then processing is advanced to Step B30.

If processing is advanced to Step B30, the control unit 70 acquires the position of the vehicle on the map or on the earth, the position of the refueling facility, and the facility area from the position information acquisition unit 30, then processing is advanced to Step B40.

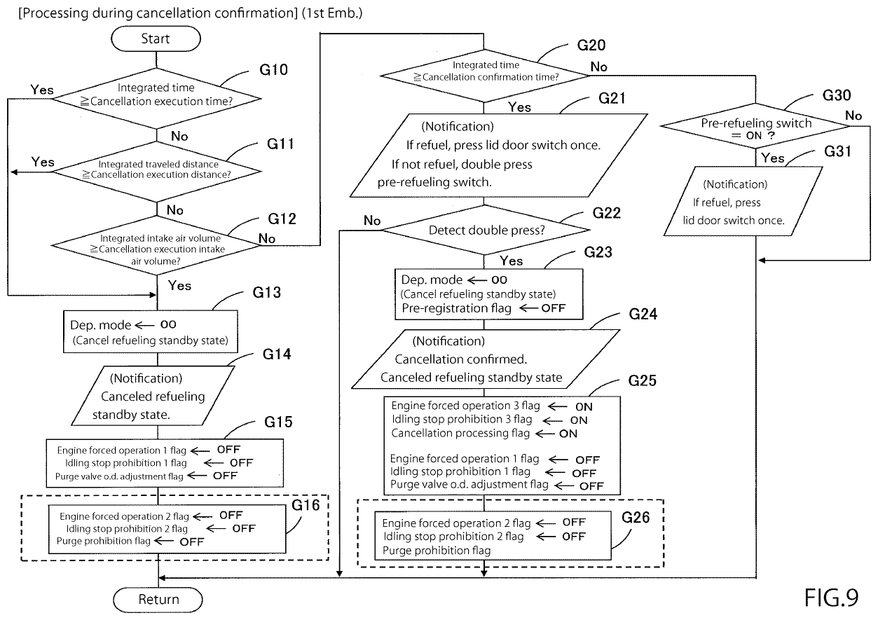

At Step B40, the control unit 70 determines whether the previous depressurization mode (the depressurization mode at the time of the previous processing) is “21” (the state immediately before manual prior depressurization is completed). At steps B40 and B41, the control unit 70 executes Step B42 at the timing when the manual prior depressurization control is completed (when the depressurization mode changes from “21” to “22”), initializes each integrated value, and starts integration. Each integrated value is used in the [Processing during cancellation confirmation] in FIG. 9. If the previous depressurization mode is “21” (Yes), processing is advanced to Step B41; otherwise (No), processing is advanced to Step B43.

If processing is advanced to Step B41, the control unit 70 determines whether the (current) depressurization mode is “22” (the state manual prior depressurization is completed). If the (current) depressurization mode is “22” (Yes), processing proceeds to Step B42; otherwise (No), processing is advanced to Step B45.

If processing is advanced to Step B42, the control unit 70 initializes (resets to zero) the integrated time, integrated travel distance, and integrated intake volume, then processing is advanced to Step B46.

When processing is advanced to Step B43, the control unit 70 determines whether the previous depressurization mode (the depressurization mode at the time of the previous processing) is “31” (the state immediately before automatic prior depressurization is completed). At Steps B43 and B44, the control unit 70 executes Step B42 at the timing when the automatic prior depressurization control is completed (when the depressurization mode changes from “31” to “32”), initializes each integrated value, and starts integration. Each integrated value is used in the [Processing during cancellation confirmation] in FIG. 9. If the previous depressurization mode is “31” (Yes), processing is advanced to Step B44; otherwise (No), processing is advanced to Step B45.

If processing is advanced to Step B44, the control unit 70 determines whether the (current) depressurization mode is “32” (the state automatic prior depressurization is completed). If the (current) depressurization mode is “32” (Yes), processing is advanced to Step B42; otherwise (No), processing is advanced to Step B45.

If processing is advanced to Step B45, the control unit 70 adds a specified time [sec], which is the interval at which the process of FIG. 4 is started, to the “integrated time” [sec], then stores the result. The control unit 70 multiplies the vehicle speed [m/sec] obtained using the vehicle speed detection unit 44 by the specified time [sec] to calculate the traveled distance [m], then adds the traveled distance [m] to the “integrated traveled distance” [m], then stores the result. The control unit 70 multiplies the intake air volume [g/sec] calculated using the intake air volume detection unit 46 by the specified time [sec] to calculate the intake air volume [g], then adds the intake air volume [g] to the “integrated intake air volume” [g], then stores the result. Then, processing is advanced to step B46.

If processing is advanced to Step B46, the control unit 70 reads the (current) depressurization mode and stores it in the “previous depressurization mode.” Then, the processing shown in FIG. 5 is terminated, and processing returns after Step A00 in FIG. 4.

FIG. 6 is a flowchart explaining the details of the “Notification processing” at Step A02 in FIG. 4. When the control unit 70 executes the “Notification processing” of Step A02 in FIG. 4, the control unit 70 advances the process to Step C10 of the “Notification processing” shown in FIG. 6.

At Step C10, the control unit 70 determines whether the depressurization mode is “00.” If the depressurization mode is “00” (Yes), since no depressurization control (general depressurization control, manual prior depressurization control, or automatic prior depressurization control) has been executed, the processing is advanced to Step C11. If the depressurization mode is not “00” (No), the control unit 70 has already executed some of depressurization control, so the control unit 70 terminates the processing shown in FIG. 6. Then, processing returns after Step A02 in FIG. 4.

If processing is advanced to Step C11, the control unit 70 determines whether the pre-refueling switch is ON. If the pre-refueling switch is ON (Yes), processing is advanced to Step C12; otherwise (No), processing is advanced to Step C13.

If processing is advanced to Step C12, the control unit 70 determines whether the position of the vehicle is within the refueling facility. If the position of the vehicle is within the refueling facility (Yes), processing is advanced to Step C40; otherwise (No), processing is advanced to Step C13. Note that whether the vehicle is within the refueling facility is determined, for example, by whether the vehicle is within the premises of the refueling facility on the map obtained by the position information acquisition unit.

If processing is advanced to Step C40, the control unit 70 outputs a notification such as “Please press the lid door switch if refueling” from the notification unit 31, terminates the processing shown in FIG. 6, then returns the processing to after Step A02 in FIG. 4. The control unit 70 prompts the user to press the lid door switch if the vehicle is within the refueling facility and the pre-refueling switch has been pressed, based on this notification.

If processing is advanced to Step C13, the control unit 70 determines whether the fuel remaining amount is less than or equal to the specified remaining amount. The specified remaining amount is set to an appropriate value confirmed through experiments using an actual vehicle or a simulator. If the fuel remaining amount is less than or equal to the specified remaining amount (Yes), processing is advanced to Step C14; otherwise (No), the control unit 70 terminates the processing shown in FIG. 6 and returns the processing after Step A02 in FIG. 4.

If processing is advanced to Step C14, the control unit 70 determines whether the tank internal pressure is higher than (atmospheric pressure+β). For example, the value of “β” is set to approximately 5 kPa. If the tank internal pressure is higher than (atmospheric pressure+β) (Yes), processing is advanced to Step C20; otherwise (No), the control unit 70 terminates the processing shown in FIG. 6 and returns the processing after Step A02 in FIG. 4.

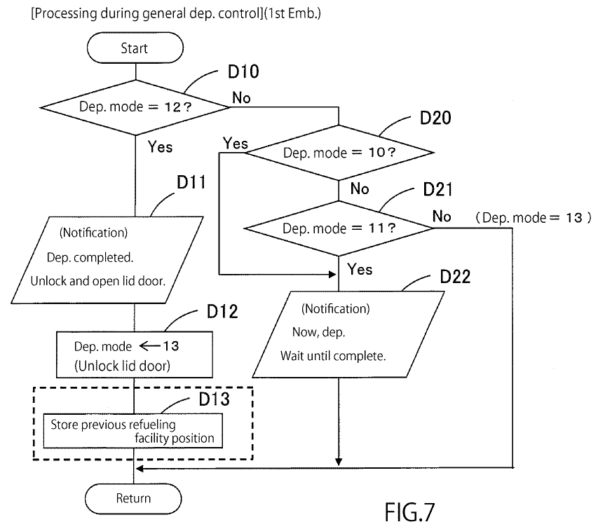

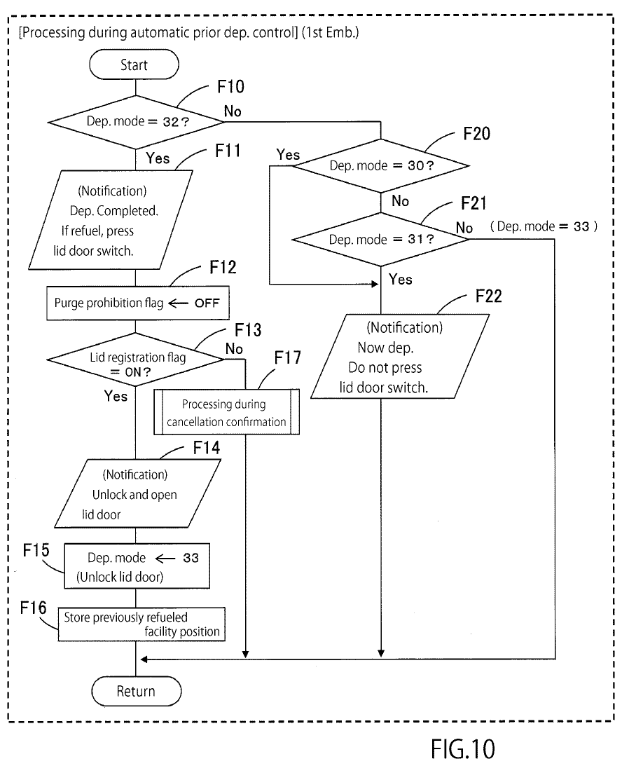

If processing is advanced to Step C20, the control unit 70 determines whether the position of the vehicle is within the specified range (at least one of the distance or estimated travel time is within the specified range) of the refueling facility position. The “refueling facility position” is the position stored at Step D13 in FIG. 7, Step E15 in FIG. 8, and Step F16 in FIG. 10, which is the position of the vehicle when the lid door was opened (i.e., the position of refueling facilities where refueling was conducted in the past). If the control unit 70 determines that the vehicle is within the specified range of the refueling facility position (Yes), processing is advanced to Step C30; otherwise (No), processing is advanced to Step C21. The control unit 70 can determine the distance or estimated travel time from the vehicle to the refueling facility based on the vehicle's position and the refueling facility position.

If processing is advanced to Step C21, the control unit 70 determines whether the position of the vehicle is within a specified range of the pre-refueling operation history position (i.e., at least one of the distance to the pre-refueling operation history position or the estimated travel time is within the specified range). The “pre-refueling operation history position” is the position of the vehicle when the pre-refueling operation unit was operated in the past, as described above, which was stored at Step A53 in FIG. 4. If the control unit 70 determines that the vehicle is within the specified range from the pre-refueling operation history position (Yes), processing is advanced to Step C30; otherwise (No), processing is advanced to Step C22.

If processing is advanced to Step C22, the control unit 70 determines whether the position of the vehicle is within the specified range of the refueling facility (at least one of the distance or estimated travel time is within the specified range). The control unit 70 can determine the distance or estimated travel time from the vehicle to the refueling facility based on the positions of the vehicle and the refueling facility. The control unit 70 sequentially acquires the position of refueling facilities near the vehicle at Step B30 in FIG. 5. If the vehicle is within the specified range of the refueling facility (Yes), processing is advanced to Step C30; otherwise (No), the control unit 70 terminates the processing shown in FIG. 6, then returns the processing after Step A02 in FIG. 4.

If processing is advanced to Step C30, the control unit 70 determines whether the re-notification timer has exceeded the re-notification time. Since frequent notifications to the user at Step C32 and Step C33 are undesirable, notifications are issued at intervals corresponding to the re-notification time (e.g., the re-notification time is set to several seconds to several tens of seconds). If the control unit 70 determines that the re-notification timer is longer than or equal to the re-notification time (Yes), processing is advanced to Step C31; otherwise (No), the control unit 70 terminates the processing shown in FIG. 6, then returns the processing after Step A02 in FIG. 4.

If the processing is advanced to Step C31, the control unit 70 determines whether the position of the vehicle is within the refueling facility. If the position of the vehicle is within the refueling facility (Yes), processing is advanced to Step C33; otherwise (No), processing is advanced to Step C32.

If processing is advanced to Step C32, the control unit 70 outputs a notification such as “You are near the refueling facility. Currently, there is no depressurization. If you wish to fuel, press the per-refueling switch” from the notification unit 31, and processing is advanced to Step C34 (see the notification before time T31 in FIGS. 21 and 22). The control unit 70 prompts the user to operate the pre-refueling operation unit 42 (to press the pre-refueling switch) if the user intends to refuel based on the notification. When issuing the notification, at least one of the following may be notified: the operational status of the pre-refueling operation unit (operational or non-operational), the depressurization status of the tank internal pressure (depressurization in progress, etc.), and whether the user intends to refuel (e.g., “If you intend to refuel, operate the pre-refueling operation unit”).

If processing is advanced to Step C33, the control unit 70 outputs a notification such as “You are in the refueling facility. Currently, there is no depressurization. If you wish to refuel, press the lid door switch” from the notification unit 31, and processing is advanced to Step C34 (see the notification before time T12 in FIG. 19 and time T22 in FIG. 20). The control unit 70 prompts the user to operate the lid door operation unit 41 (to press the lid door switch) if the user intends to refuel based on the notification. When issuing the notification, at least one of the following may be notified: the operational status of the pre-refueling operation unit (operational or non-operational), the depressurization status of the tank internal pressure (depressurization in progress, etc.), and whether the user intends to refuel (e.g., “If you intend to refuel, operate the pre-refueling operation unit”).

If processing is advanced to Step C34, the control unit 70 initializes (resets to zero) the re-notification timer, terminates the processing shown in FIG. 6, and returns processing after Step A02 in FIG. 4.

FIG. 7 is a flowchart explaining the details of “Processing during general depressurization” Step A12 in FIG. 4.

The general depressurization control is a depressurization control that is initiated when the user operates the lid door operation unit 41 upon arrival at the refueling facility (or just before arriving at the refueling facility), and corresponds to conventional depressurization control (a waiting time similar to that of conventional control occurs). In general depressurization control, the control unit 70 changes the depressurization mode from 10 to 11, 12, and 13, and executes depressurization. First, the operational states for each of the depressurization modes “10,” “11,” “12,” and “13” will be described.

When the depressurization mode is “10” (see time T12 to T13 in FIG. 19 and time T22 to T23 in FIG. 20), the control unit 70 gradually opens the shut-off valve 61 toward (FA %) and gradually reduces the tank internal pressure toward (atmospheric pressure+α) (in general depressurization state). When the tank internal pressure drops less than or equal to (atmospheric pressure+α), the control unit 70 changes the depressurization mode to “11” (see time T13 in FIG. 19 and time T23 in FIG. 20). For example, the value of “α” is approximately 0.2 kPa.

When the depressurization mode is “11” (see time T13 to T14 in FIG. 19, time T23 to T24 in FIG. 20), the control unit 70 gradually opens the shut-off valve 61 from opening degree (FA %) to 100% after the tank internal pressure becomes less than or equal to (atmospheric pressure+α), thereby depressurizing the tank internal pressure from (atmospheric pressure+α) to atmospheric pressure (in general depressurization completion preparation state). When the opening degree of the shut-off valve 61 reaches 100%, the control unit 70 changes the pressure reduction mode to “12” (see time T14 in FIG. 19 and time T24 in FIG. 20).

When the depressurization mode is “12” (see time T14 to T15 in FIG. 19 and time T24 to T25 in FIG. 20), the depressurization of the tank internal pressure is complete (in general depressurization complete state), and the lid door 50 can be unlocked and opened at any time. The general depressurization control is started when the user not only intends to refuel but also intends to open the lid door 50, and the operation of the lid door operation unit 41 is executed. Therefore, after changing the depressurization mode to “12” (in after the general depressurization completion state), the control unit 70 changes the depressurization mode to “13” without waiting for the operation of the lid door operation unit 41. Then, the lid door 50 is unlocked and opened (see time T15 in FIG. 19 and time T25 in FIG. 20).

When the depressurization mode is “13” (see time T15 to T16 in FIG. 19 and time T25 to T26 in FIG. 20), the lid door 50 is unlocked and opened (in the lid door open state). In this state, the user can open the fuel cap and refuel. When the user completes refueling, attaches the fuel cap, and closes the lid door 50, the control unit 70 changes the depressurization mode to “00” (see time T16 in FIG. 19 and time T26 in FIG. 20).

When the control unit 70 executes the [Processing during general depressurization control] at Step A12 in FIG. 4, processing is advanced to Step D10 of the [Processing during general depressurization control] shown in FIG. 7.

At Step D10, the control unit 70 determines whether the depressurization mode is “12.” If the depressurization mode is “12” (Yes), processing is advanced to Step D11; otherwise (No), processing is advanced to Step D20.

If processing is advanced to Step D11, the control unit 70 outputs a notification such as “Depressurization complete. Unlock and open the lid door” from the notification unit 31 (see time T14 in FIG. 19 and time T24 in FIG. 20), then processing is advanced to Step D12. The control unit 70 notifies the user that the lid door 50 can be unlocked and opened even if the user does not operate the lid door operation unit 41.

At Step D12, the control unit 70 sets the depressurization mode to “13” and processing is advanced to Step D13. After setting the depressurization mode to “13,” the control unit 70 unlocks and opens the lid door 50 at the “Controlling shut-off valve and lid lock” described below.

At Step D13, the control unit 70 stores the current position of the vehicle (the position where the lid door 50 is unlocked and opened, i.e., the position of the refueling facility where refueling was conducted) as the refueling facility position. Then, the control unit 70 ends the processing shown in FIG. 7 and returns the processing after Step A12 in FIG. 4.

If processing is advanced to Step D20, the control unit 70 determines whether the depressurization mode is “10.” If the depressurization mode is “10” (Yes), processing is advanced to Step D22; otherwise (No), processing is advanced to Step D21.

If processing is advanced to Step D21, the control unit 70 determines whether the depressurization mode is “11.” If the depressurization mode is “11” (Yes), processing is advanced to Step D22; otherwise (No), the control unit 70 terminates the processing shown in FIG. 7 and returns the processing after Step A12 in FIG. 4.

If processing is advanced to Step D22, the control unit 70 outputs a notification such as “Depressurization is in progress. Please wait until pressurization is complete” from the notification unit 31 (see time T12 to T14 in FIG. 19 and time T22 to T24 in FIG. 20), and terminates the processing shown in FIG. 7. Then, the control unit 70 returns the processing after Step A12 in FIG. 4. The notification at Step D22 is preferably made at specified time intervals of, for example, a few seconds.

FIG. 8 is a flowchart explaining the details of “Processing during manual prior depressurization control” at Step A22 in FIG. 4.

The manual prior depressurization control is a depressurization control that starts when the user operates the pre-refueling operation unit 42 prior to operating the lid door operation unit 41, just before reaching the refueling facility. In manual prior depressurization control, the control unit 70 changes the depressurization mode from 20 to 21, 22, and 23 to execute depressurization. First, the operating status for each of depressurization modes “20,” “21,” “22,” and “23” will be described.

The state where the depressurization mode is “20” (see time T31 to T34 in FIGS. 21 and 22) is the state where the control unit 70 gradually opens the shut-off valve 61 toward the opening degree (FB %), gradually reducing the tank internal pressure toward (atmospheric pressure+α). Such a state is called the manual prior depressurization state. However, when the depressurization mode is set to “20,” first, the engine is started (at time T31), purge control is executed (at time T32), and the shut-off valve is opened after the purge valve opening degree is greater than or equal to (PS %) (at time T33). Then, the control unit 70 changes the depressurization mode to “21” when the tank internal pressure becomes lower than or equal to (atmospheric pressure+α) (see time T34 in FIGS. 21 and 22). For example, the value of “α” is approximately 0.2 kPa.

The state where the depressurization mode is “21” (see at time T34 to T35 in FIGS. 21 and 22) is the state where the control unit 70 is gradually adjusting the opening degree of the shut-off valve 61 from (FB %) to (FK %) after the tank internal pressure is less than or equal to (atmospheric pressure+α). Such a state is called a manual prior depressurization complete preparing state. (FK %) is the opening degree during normal operation. When the opening degree of the shut-off valve 61 becomes within the range of (FK %±ΔK %), the control unit 70 changes the depressurization mode to “22” (see at time T35 in FIGS. 21 and 22).

The state where the depressurization mode is “22” (see time T35 to T37 in FIG. 21) is the state where the depressurization of the tank internal pressure is completed (a manual prior depressurization complete state), and the lid door 50 can be unlocked and opened at any time (a refueling standby state). In the manual prior depressurization control, after changing the depressurization mode to “22” (after the manual prior depressurization complete state), if the user operates the lid door operation unit 41, the control unit 70 changes the depressurization mode to “23,” unlocks the lid door 50, and opens it (see time T37 in FIG. 21).

The state where the depressurization mode is “23” (see time T37 to T38 in FIG. 21) is the state where the lid door 50 is unlocked and opened (a lid door open state). In this state, the user can open the fuel cap and refuel. When the user completes refueling, attaches the fuel cap, and closes the lid door 50, then the control unit 70 changes the depressurization mode to “00” (see time T38 in FIG. 21).

If the control unit 70 executes the [Processing during the manual prior depressurization control] at Step A22 in FIG. 4, processing is advanced to Step E10 of the [Processing during the manual prior depressurization control] shown in FIG. 8.

At Step E10, the control unit 70 determines whether the depressurization mode is “22.” If the depressurization mode is “22” (Yes), processing is advanced to Step E11; otherwise (No), processing is advanced to Step E20.

If processing is advanced to Step E11, the control unit 70 outputs a notification such as “Depressurization complete. Press the lid door switch to refuel” from the notification unit 31 (see time T35 to T37 in FIG. 21), then processing is advanced to Step E12. The control unit 70 notifies that the lid door operation unit 41 can be operated when the tank internal pressure is less than or equal to a specified pressure (atmospheric pressure+α), then accepts operation of the lid door operation unit 41 at Step E12. The control unit 70 prompts the user to operate the lid door operation unit 41 (the lid door switch) if the user intends to refuel based on the notification. The notification at Step E11 is preferably made at a specified time interval of, for example, several seconds.

At Step E12, the control unit 70 determines whether the lid registration flag is ON. If the lid registration flag is ON (Yes), processing is advanced to Step E13; otherwise (No), processing is advanced to Step E16.

If processing is advanced to Step E13, the control unit 70 outputs a notification such as “Unlock and open the lid door” from the notification unit 31 (see time T37 in FIG. 21), then processing is advanced to Step E14. The control unit 70 notifies that the lid door 50 will be unlocked and opened in response to the user's operation of the lid door operation unit 41.

At Step E14, the control unit 70 sets the depressurization mode to “23”, the processing is advanced to Step E15. After setting the depressurization mode to “23,” the control unit 70 unlocks and opens the lid door 50 at the “Controlling shut-off valve and lid lock” described below.

At Step E15, the control unit 70 stores the current position of the vehicle (the position where the lid door 50 is unlocked and opened, i.e., the position of the refueling facility where refueling was conducted) as the refueling facility position, then processing is advanced to Step E30.

If processing is advanced to Step E30, the control unit 70 sets the engine forced operation 1 flag, the idling stop prohibition 1 flag, and the purge valve opening degree adjustment flag to OFF (see time T37 in FIG. 21), and terminates the processing shown in FIG. 8. Then, the control unit 70 returns the processing after Step A22 in FIG. 4.

If processing is advanced to Step E16, the control unit 70 executes the [Processing during cancellation confirmation], terminates the processing shown in FIG. 8, then returns the processing after Step A22 in FIG. 4. Details of the [Processing during cancellation confirmation] will be described later.

If processing is advanced to Step E20, the control unit 70 determines whether the depressurization mode is “20.” If the depressurization mode is “20” (Yes), processing is advanced to Step E22; otherwise (No), processing is advanced to Step E21.

If processing is advanced to Step E21, the control unit 70 determines whether the depressurization mode is “21.” If the depressurization mode is “21” (Yes), processing is advanced to Step E22; otherwise (No), the control unit 70 terminates the processing shown in FIG. 8, then returns the processing after Step A22 in FIG. 4.

If processing is advanced to Step E22, the control unit 70 determines whether the ignition is OFF. If the ignition is OFF (Yes), processing is advanced to Step E25; otherwise (No), processing is advanced to Step E23.

If processing is advanced to Step E23, the control unit 70 determines whether the position of the vehicle is within the refueling facility. If the position of the vehicle is within the refueling facility (Yes), processing is advanced to Step E25; otherwise (No), processing is advanced to Step E24.

If processing is advanced to Step E24, the control unit 70 outputs a notification such as “Depressurization in progress. You cannot p the lid door switch yet” from the notification unit 31 (see time T31 to T35 in FIGS. 21 and 22), and terminates the processing shown in FIG. 8. Then, the control unit 70 returns the processing after Step A22 in FIG. 4. The control unit 70 notifies the user cannot press the lid door switch (the lid door operation unit 41 cannot be operated). The notification at Step E24 is preferably made at a specified time interval of, for example, several seconds.

If processing is advanced to Step E25, the control unit 70 sets the depressurization mode to “00” to cancel the manual prior depressurization control, then processing is advanced to Step E26. The control unit 70 cancels the manual prior depressurization control when the ignition is turned OFF or the vehicle enters the refueling facility at a stage just before the manual prior depressurization control is completed. Furthermore, the control unit 70 sets the lid operation waiting flag to ON at Step E27 and waits for the user to operate the lid door operation unit 41 (the lid door switch) without executing the automatic prior depressurization control described below (see Step A63 in FIG. 4).

At Step E26, the control unit 70 outputs a notification such as “Depressurization canceled. Press the lid door switch to refuel” from the notification unit 31, then processing is advanced to Step E27.

At Step E27, the control unit 70 sets the lid operation waiting flag to ON, then processing is advanced to Step E28. The lid operation waiting flag is a flag which is set to OFF at Step H71 in FIG. 11 and used at Step A63 in FIG. 4.

At Step E28, the control unit 70 initializes (resets to zero) the lid operation waiting timer, then processing is advanced to Step E30.

FIG. 9 is a flowchart explaining the details of the [Processing during cancellation confirmation] at Step E16 in FIG. 8. When the control unit 70 executes the [Processing during cancellation confirmation] at Step E16 in FIG. 8, processing is advanced to Step G10 of the [Processing during cancellation confirmation] shown in FIG. 9. The [Processing during cancellation confirmation] at Step F17 in FIG. 10 is also the processing shown in FIG. 9.

The control unit 70 unlocks and opens the lid door 50 when the user operates the lid door operation unit 41 after the refueling standby state of the depressurization mode “22” where manual prior depressurization is complete (or after the refueling standby state of the depressurization mode “32” where automatic prior depressurization is complete). However, there may be cases where the user no longer intends to refuel for some reason and does not operate the lid door operation unit 41. In such a case (when the vehicle's driving state reaches a specified driving state), the control unit 70 cancels the refueling standby state caused by manual prior depressurization control (or automatic prior depressurization control). Note that whether the specified driving state has been reached is determined based on integrated time, integrated traveled distance, and integrated intake volume.

At Step G10, the control unit 70 determines whether the integrated time is longer than or equal to the cancellation execution time. The “integrated time” is the elapsed time from the point at which manual prior depressurization was completed when the depressurization mode was changed from “21” to “22” (or the point at which automatic prior depressurization was completed when the depressurization mode was changed from “31” to “32”) as shown in Steps B40 to B45 in FIG. 5. The “cancellation execution time” is a time longer than the “cancellation confirmation time” at Step G20. The cancellation execution time is, for example, approximately 10 minutes to several hours. If the integrated time is longer than or equal to the cancellation execution time (Yes), processing is advanced to Step G13; otherwise (No), processing is advanced to Step G11.

If processing is advanced to Step G11, the control unit 70 determines whether the integrated traveled distance is longer than or equal to the cancellation execution distance. The “integrated traveled distance” is the integrated value of the traveled distance from the point at which manual prior depressurization was completed when the depression mode changed from “21” to “22” (or the point at which automatic prior depressurization was completed when the depressurization mode was changed from “31” to “32”), as shown in Steps B40 to B45 in FIG. 5. The “cancellation execution distance” is, for example, a distance of approximately several km to 10 km. If the integrated traveled distance is longer than or equal to the cancellation execution distance (Yes), processing is advanced to Step G13; otherwise (No), processing is advanced to Step G12.

If processing is advanced to Step G12, the control unit 70 determines whether the integrated intake air volume is greater than or equal to the cancellation execution intake air volume. The “integrated intake air volume” is the integrated value of the intake air volume from the point at which manual prior depressurization is completed when the depressurization mode changes from “21” to “22” (or from the point at which automatic prior depressurization is completed when the depressurization mode changes from “31” to “32”, as shown in Steps B40 to B45 in FIG. 5. The “cancellation execution intake air volume” is set to an appropriate value confirmed through experiments using an actual vehicle or simulations. If the control unit 70 determines that the integrated intake air volume is greater than or equal to the cancellation execution intake air volume (Yes), processing is advanced to Step G13; otherwise (No), processing is advanced to Step G20.

If processing is advanced to Step G13, the control unit 70 sets the depressurization mode to “00” to cancel (release) the refueling standby state (waiting for manual prior depressurization or automatic prior depressurization to be completed and the lid door switch to be pressed), then processing is advanced to Step G14.

At Step G14, the control unit 70 outputs a notification such as “Refueling standby state was canceled” from the notification unit 31, then processing is advanced to Step G15.

At Step G15, the control unit 70 sets the engine forced operation 1 flag, the idling stop prohibition 1 flag, and the purge valve opening degree adjustment flag to OFF, respectively, then processing is advanced to Step G16. Since the engine has been operated for a sufficiently long time, or a sufficiently long distance, or with a sufficient intake air volume, the vapor concentration in the canister is estimated to be low. Therefore, these flags are set to OFF along with the cancellation of the refueling standby state.

At Step G16, the control unit 70 sets the engine forced operation 2 flag, the idling stop prohibition 2 flag, and the purge prohibition flag to OFF, respectively, and terminates the processing shown in FIG. 9, then returns the processing after the Step E16 in FIG. 8. Since the engine has been operated for a sufficiently long time, or a sufficiently long distance, or with a sufficient intake air volume, the vapor concentration in the canister is estimated to be low. Therefore, these flags are set to OFF along with the cancellation of the refueling standby state.

If the processing is advanced to Step G20, the control unit 70 determines whether the integrated time is longer than or equal to the cancellation confirmation time. The “cancellation confirmation time” is a time shorter than the “cancellation execution time” at Step G10. The cancellation confirmation time is, for example, approximately several minutes to several 10 minutes. If the integrated time is longer than or equal to the cancellation confirmation time (Yes), processing is advanced to Step G21; otherwise (No), processing is advanced to Step G30.

If processing is advanced to Step G21, the control unit 70 outputs a notification such as “If refueling, press the lid door switch once. If not refueling, execute the cancellation operation by pressing the pre-refueling switch twice” from notification unit 31, then processing is advanced to Step G22. The notification at Step G21 is preferably not repeated until a specified time has elapsed after it is first notified.

At Step G22, the control unit 70 determines whether the pre-refueling switch (the pre-refueling operation unit 42) has been pressed twice, which means cancellation operation by the user. The determination at Step G22 is made based on the pre-refueling switch, not the pre-registration flag. If the control unit 70 detects a double press of the pre-refueling switch (Yes), processing is advanced to Step G23; otherwise (No), the control unit 70 terminates the processing shown in FIG. 9, then returns the processing after Step E16 in FIG. 8.

If processing is advanced to Step G23, the control unit 70 sets the depressurization mode to “00” and cancels the refueling standby state (a state in which the control unit is waiting for manual prior depressurization or automatic prior depressurization to be completed and the lid door switch to be pressed). The control unit 70 sets the pre-registration flag to OFF to prevent the start of “manual prior depressurization control”, then processing is advanced to Step G24.

At Step G24, the control unit 70 outputs a notification such as “Cancellation operation confirmed. Refueling standby state canceled” from the notification unit 31, then processing is advanced to Step G25.

At Step G25, the control unit 70 sets the engine forced operation 3 flag, the idling stop prohibition 3 flag, and the cancellation processing flag to ON, respectively, and sets the engine forced operation 1 flag, the idling stop prohibition 1 flag, and the purge valve opening degree adjustment flag to OFF, respectively. Then, processing is advanced to Step G26. The engine forced start 3 flag is a flag that forces the engine to start when the ignition is set to ON and the engine is in a stopped state. The idling stop prohibition 3 flag is a flag that prohibits the operation of the idling stop function. In other words, after the processing of Step G25, if the ignition is ON, the engine will be in a running state (see time T3B in FIG. 22).

If the user cancels the refueling standby state, the vapor concentration in the canister may be high due to depressurization. Therefore, to lower the vapor concentration, the engine forced operation 3 flag, the idling stop prohibition 3 flag, and the cancellation processing flag are temporarily set to ON, and all other flags are set to OFF. The engine forced operation 3 flag is a flag that forces the engine to operate when the ignition is set to ON, and it is set to OFF at Step H62 in FIG. 11. The idling stop prohibition 3 flag is a flag that prohibits the operation of the idling stop function and is set to OFF at Step H62 in FIG. 11. The cancellation processing flag is a flag which is used at Step H60 in FIG. 11 and set to OFF at Step H62, also used to set the engine forced operation 3 flag and the idling stop prohibition 3 flag to OFF.

At Step G26, the control unit 70 sets the engine forced operation 2 flag, the idling stop prohibition 2 flag, and the purge prohibition flag to OFF, respectively. Then, the control unit 70 terminates the processing shown in FIG. 9, then returns the processing after Step E16 in FIG. 8.

If processing is advanced to Step G30, the control unit 70 determines whether the pre-refueling switch is ON. The determination at Step G30 is made based on the pre-refueling switch rather than the pre-registration flag. If the pre-refueling switch is ON (Yes), processing is advanced to Step G31; otherwise (No), the control unit 70 terminates the processing shown in FIG. 9, then returns the processing after Step E16 in FIG. 8.

If processing is advanced to Step G31, the control unit 70 outputs a notification such as “If refueling, press the lid door switch once” from the notification unit 31, terminates the processing shown in FIG. 9, and returns the processing after Step E16 in FIG. 8.

FIG. 10 is a flowchart explaining the details of the “Processing during automatic prior depressurization” at Step A32 in FIG. 4.

The automatic prior depressurization control is a depressurization control that automatically starts when the vehicle enters the refueling facility while the user is not operating either the lid door operation unit 41 or the pre-refueling operation unit 42. In automatic prior depressurization control, the control unit 70 changes the depressurization mode from 30 to 31, 32, and 33 to execute depressurization. First, the operational states for each of the depressurization modes “30,” “31,” “32,” and “33” will be described.

The state where the depressurization mode is “30” (see time T54 to T55 in FIG. 23) is the state where the control unit 70 gradually opens the shut-off valve 61 toward opening degree of 100%, gradually reducing the tank pressure toward (atmospheric pressure+α) (the automatic prior depressurization state). When the tank internal pressure drops less than or equal to (atmospheric pressure+α), the control unit 70 changes the depressurization mode to “31” (see time T55 in FIG. 23). The value of “α” is, for example, approximately 0.2 kPa. In the aforementioned “manual prior depressurization control,” during the manual prior depressurization state (depressurization mode is “20”), the opening degree of the shut-off valve 61 was set to (FB %), which is other than 100%, to depressurize (see time T33 to T34 in FIG. 21). In contrast, in the “automatic prior depressurization control,” since the vehicle has already entered the refueling facility, during the automatic prior depressurization state (depressurization mode is “30”), the opening degree of the shut-off valve 61 is set to 100% to depressurize quickly (see time T54 to T55 in FIG. 23).

The state where the depressurization mode is “31” (see time T55 to T56 in FIG. 23) is the state where the control unit 70 gradually adjusts the opening degree of the shut-off valve 61 from 100% to 0% after the tank internal pressure becomes less than or equal to (atmospheric pressure+α) (the automatic prior depressurization completion preparation state). When the opening degree of the shut-off valve 61 reaches 0%, the control unit 70 changes the depressurization mode to “32” (see time T56 in FIG. 23).

The state where the depressurization mode is “32” (see time T56 to T58 in FIG. 23) is the state where the depressurization has been completed (the automatic prior depressurization completion state) and the lid door 50 can be unlocked and opened at any time (the refueling standby state). In the automatic prior depressurization control, after changing the depressurization mode to “32” (after the automatic prior depressurization completion state), if the user operates the lid door operation unit 41, the control unit 70 changes the depressurization mode to “33,” then unlocks and opens the lid door 50 (see time T58 in FIG. 23).

The state where the depressurization mode is “33” (see time T58 to T59 in FIG. 23) is the state where the lid door 50 is unlocked and opened (the lid door opened state). In this state, the user can open the fuel cap and refuel. After the user completes refueling, attaches the fuel cap, and closes the lid door 50, the control unit 70 changes the depressurization mode to “00” (see time T59 in FIG. 23).

If the control unit 70 executes the [Processing during automatic prior depressurization control] at Step A32 in FIG. 4, processing is advanced to Step F10 of the [Processing during automatic prior depressurization control] shown in FIG. 10.

At Step F10, the control unit 70 determines whether the depressurization mode is “32.” If the depressurization mode is “32” (Yes), processing is advanced to Step F11; otherwise (No), processing is advanced to Step F20.

If processing is advanced to Step F11, the control unit 70 outputs a notification such as “Depressurization complete. Press the lid door switch to refuel” from the notification unit 31 (see time T56 to T58 in FIG. 23), then processing is advanced to Step F12. The control unit 70 notifies that the lid door operation unit 41 can be operated when the tank internal pressure is less than or equal to the specified pressure (atmospheric pressure+α), then accepts operation of the lid door operation unit 41 at Step F13. The control unit 70 prompts the user to operate the lid door operation unit 41 (the lid door switch) if the user intends to refuel based on the above notification. The notification at Step F11 is preferably made at a specified time interval of, for example, a few seconds.

At Step F12, the control unit 70 sets the purge prohibition flag to OFF, then processing is advanced to Step F13. The purge prohibition flag is the flag which set to ON at Step A68 in FIG. 4 and prohibits purge control during automatic prior depressurization.

At Step F13, the control unit 70 determines whether the lid registration flag is ON. If the lid registration flag is ON (Yes), processing is advanced to Step F14; otherwise(No), processing is advanced to Step F17.

If processing is advanced to Step F14, the control unit 70 outputs a notification such as “Unlocking and opening the lid door” from the notification unit 31 (see time T58 in FIG. 23), then processing is advanced to Step F15. The control unit 70 notifies that the lid door 50 will be unlocked and opened in response to the user's operation of the lid door operation unit 41.

At Step F15, the control unit 70 sets the depressurization mode to “33”, then processing is advanced to Step F16. After setting the depressurization mode to “33,” the control unit 70 unlocks and opens the lid door 50 in the [Controlling shut-off valve and the lid lock] described below.

At step F16, the control unit 70 stores the current position of the vehicle (the position where the lid door 50 is unlocked and opened, i.e., the position of the refueling facility where the user has refueled) as a previously refueled facility position, completes the processing shown in FIG. 10, and returns the processing after Step A32 in FIG. 4.

If processing is advanced to Step F17, the control unit 70 executes the [Processing during cancellation confirmation], completes the processing shown in FIG. 10, then returns the processing after Step A32 in FIG. 4. Details of the [Processing during cancellation confirmation] have already been explained with reference to FIG. 9.

If the processing is advanced to Step F20, the control unit 70 determines whether the depressurization mode is “30.” If the depressurization mode is “30” (Yes), processing is advanced to Step F22; otherwise (No), processing is advanced to Step F21.

If the processing is advanced to Step F21, the control unit 70 determines whether the depressurization mode is “31.” If the depressurization mode is “31” (Yes), processing is advanced to Step F22; otherwise (No), the control unit 70 terminates the processing shown in FIG. 10 and returns the processing after Step A32 in FIG. 4.

If processing is advanced to Step F22, the control unit 70 outputs a notification such as “Depressurization in progress. The lid door switch cannot be pressed yet” from notification unit 31 (see time T54 to T56 in FIG. 23), and terminates the processing shown in FIG. 10, then returns the processing after Step A32 in FIG. 4. The control unit 70 notifies the user that the lid door switch cannot be pressed (the lid door operation unit 41 cannot be operated). The notification at Step F22 is preferably made at a specified time interval of, for example, several seconds.

FIG. 11 is a flowchart explaining the details of the [Controlling shut-off valve and lid lock] at Step A80 in FIG. 4. When the control unit 70 executes the [Controlling shut-off valve and lid lock] at Step A80 in FIG. 4, processing is advanced to the [Controlling shut-off valve and lid lock] at Step H10 in FIG. 11.

At Step H10, the control unit 70 determines whether general depressurization control is being executed. If general depressurization control is being executed (Yes), processing is advanced to Step H11; otherwise (No), processing is advanced to Step H20. The control unit 70 determines that general depressurization control is being executed when the depressurization mode is “1*.”

If processing is advanced to Step H11, the control unit 70 executes [Controlling general depressurization], then processing is advanced to Step H50. Details of [Controlling general depressurization] will be described later.

At Step H20, the control unit 70 determines whether manual prior depressurization control is being executed. If manual prior depressurization control is being executed (Yes), processing is advanced to Step H21; otherwise (No), processing is advanced to Step H30. The control unit 70 determines that manual prior depressurization control is being executed when the depressurization mode is “2*”.

If processing is advanced to Step H21, the control unit 70 executes [Controlling manual prior depressurization], then processing is advanced to Step H50. Details of [Controlling manual prior depressurization] will be described later.

At Step H30, the control unit 70 determines whether automatic prior depressurization control is being executed. If automatic prior depressurization control is being executed (Yes), processing is advanced to Step H31; otherwise (No), processing is advanced to Step H40. The control unit 70 determines that automatic prior depressurization control is being executed when the depressurization mode is “3*.”

If processing is advanced to Step H31, the control unit 70 executes [Controlling automatic prior depressurization], then processing is advanced to Step H50. Details of [Controlling automatic prior depressurization] will be described later.

If processing is advanced to Step H40, the control unit 70 determines whether the purge valve opening degree is greater than or equal to the specified purge valve opening degree (PS %). If the purge valve opening degree is greater than or equal to the specified purge valve opening degree (PS %) (Yes), processing is advanced to Step H41; otherwise (No), processing is advanced to Step H42. The value of the specified purge valve opening degree (PS %) is set to an appropriate value confirmed through experiments using actual vehicles or simulations, etc.

If processing is advanced to Step H41, the control unit 70 calculates the target shut-off valve opening degree (FK %) corresponding to the purge valve opening degree, sets (FK %) as the target shut-off valve opening degree. Then, processing is advanced to Step H50. The control unit 70, for example, uses the [Target shut-off valve opening degree characteristics 4] shown in FIG. 15 to determine the target shut-off valve opening degree (FK %).

If processing is advanced to Step H42, the control unit 70 sets the target shut-off valve opening degree 0% (fully closed), then processing is advanced to Step H50.

If processing is advanced to Step H50, the control unit 70 gradually changes the opening degree of the shut-off valve 61 to approach the target shut-off valve opening degree, then processing is advanced to Step H60.

At Step H60, the control unit 70 determines whether the cancellation processing flag is ON. The cancellation processing flag is a flag set to ON at Step G25 in FIG. 9, and is used to maintain the engine forced operation 3 flag and the idling stop prohibition 3 flag in the ON state until the vapor concentration in the canister becomes below or equal to the specified vapor concentration (VS %) after executing the cancellation processing at Steps G23 to G26 in FIG. 9. If the cancellation processing flag is ON (Yes), processing is advanced to Step H61; otherwise (No), processing is advanced to Step H70.

If processing is advanced to Step H61, the control unit 70 determines whether the vapor concentration in the canister is less than or equal to the specified vapor concentration (VS %). The vapor concentration is calculated based on the intake air volume, engine RPM, fuel injection amount, purge valve opening, air-fuel ratio, etc. under existing purge control. The value of the specified vapor concentration (VS %) is set to an appropriate value confirmed through experiments using actual vehicles or simulations. If the vapor concentration is less than or equal to the specified vapor concentration (VS %) (Yes), processing is advanced to Step H62; otherwise (No), processing is advanced to Step H70.

If processing is advanced to Step H62, the control unit 70 sets the engine forced operation 3 flag, the idling stop prohibition 3 flag, and the cancellation processing flag to OFF, respectively, then processing is advanced to Step H70.

If processing is advanced to Step H70, the control unit 70 determines whether the lid operation waiting timer has exceeded the specified waiting time. The specified waiting time is set to a value such as approximately several 10 seconds to several 10 minutes. The lid operation waiting flag is a flag set to ON at Step E27 in FIG. 8 and used at Step A63 in FIG. 4. If the lid operation waiting timer is greater than or equal to the specified waiting time, processing is advanced to Step H71; otherwise (No), the control unit 70 terminates the processing shown in FIG. 11, then returns the processing after Step A80 in FIG. 4.

If processing is advanced to Step H71, the control unit 70 sets the lid operation waiting flag to OFF, terminates the processing shown in FIG. 11, and returns the processing after Step A80 in FIG. 4.

FIG. 12 is a flowchart explaining the details of the [Controlling general depressurization] at Step H11 in FIG. 11. When executing the [Controlling general depressurization] at Step H11 in FIG. 11, processing is advanced to Step J10 of the [Controlling general depressurization] shown in FIG. 12.

At Step J10, the control unit 70 determines whether the depressurization mode is “10.” If the depressurization mode is “10” (Yes), processing is advanced to Step J11; otherwise (No), processing is advanced to Step J20.

If processing is advanced to Step J11, the control unit 70 calculates the target shut-off valve opening degree (FA %), sets (FA %) as the target shut-off valve opening degree, then processing is advanced to Step J12. When the depressurization mode is “10,” the control unit 70 gradually changes the opening degree of the shut-off valve 61 toward (FA %) (see time T12 to T13 in FIG. 19 and time T22 to T23 in FIG. 20). The target shut-off valve opening degree (FA %) may be a fixed value or a value obtained using a map that sets values based on the tank internal pressure or the like.

At Step J12, the control unit 70 determines whether the tank internal pressure is less than or equal to (atmospheric pressure+α). The value of “α” is, for example, approximately 0.2 kPa. If the tank internal pressure is less than or equal to (atmospheric pressure+α) (Yes), processing is advanced to Step J13; otherwise (No), the control unit 70 terminates the processing shown in FIG. 12 and returns the processing after Step H11 in FIG. 11.

If processing is advanced to Step J13, the control unit 70 sets the depressurization mode to “11” (see time T13 in FIG. 19 and time T23 in FIG. 20), terminates the processing shown in FIG. 12, then returns the processing after Step H11 in FIG. 11.

If processing is advanced to Step J20, the control unit 70 determines whether the depressurization mode is “11.” If the depressurization mode is “11” (Yes), processing is advanced to Step J21; otherwise (No), processing is advanced to Step J30.

If processing is advanced to Step J21, control unit 70 sets the target shut-off valve opening degree to 100%, then processing is advanced to Step J22. If the depressurization mode is “11,” the control unit 70 gradually changes the opening degree of the shut-off valve 61 toward 100% (see time T13 to T14 in FIG. 19 and time T23 to T24 in FIG. 20).

At Step J22, the control unit 70 determines whether the shut-off valve opening is 100%. If the shut-off valve opening degree is 100% (Yes), processing is advanced to Step J23; otherwise (No), the control unit 70 terminates the processing shown in FIG. 12, then returns the processing after Step H11 in FIG. 11.

If processing is advanced to Step J23, the control unit 70 sets the depressurization mode to “12” (see time T14 in FIG. 19 and time T24 in FIG. 20), terminates the processing shown in FIG. 12, then returns the processing after Step H11 in FIG. 11.

If processing is advanced to Step J30, the control unit 70 determines whether the depressurization mode is “12.” If the depressurization mode is “12” (Yes), processing is advanced to Step J31; otherwise (No), processing is advanced to Step J41.

If processing is advanced to Step J31, the control unit 70 sets the target shut-off valve opening degree to 100% (see time T14 to T15 in FIG. 19 and time T24 to T25 in FIG. 20), terminates the processing shown in FIG. 12, then returns the processing after Step H11 in FIG. 11.

If processing is advanced to Step J41 (in this case, the depressurization mode is “13”), the control unit 70 sets the target shut-off valve opening degree to 100% (see time T15 to T16 in FIG. 19 and time T25 to T26 in FIG. 20), then processing is advanced to Step J42.

At Step J42, the control unit 70 determines whether the previous depressurization mode is “12.” If the previous depressurization mode is “12” (Yes), processing is advanced to Step J43; otherwise (No), processing is advanced to Step J44.

If processing is advanced to Step J43, the control unit 70 initializes (resets to zero) the unlocking timer, then processing is advanced to Step J44. The control unit 70 initializes the unlocking timer at the timing when the depressurization mode changes from “12” to “13” (the timing when the lid door is opened from the general depressurization completion state).

If processing is advanced to Step J44, the control unit 70 executes [Controlling lid door lock] to terminate the processing shown in FIG. 12, then returns processing after Step H11 in FIG. 11. Details of [Controlling lid door lock] will be described later.

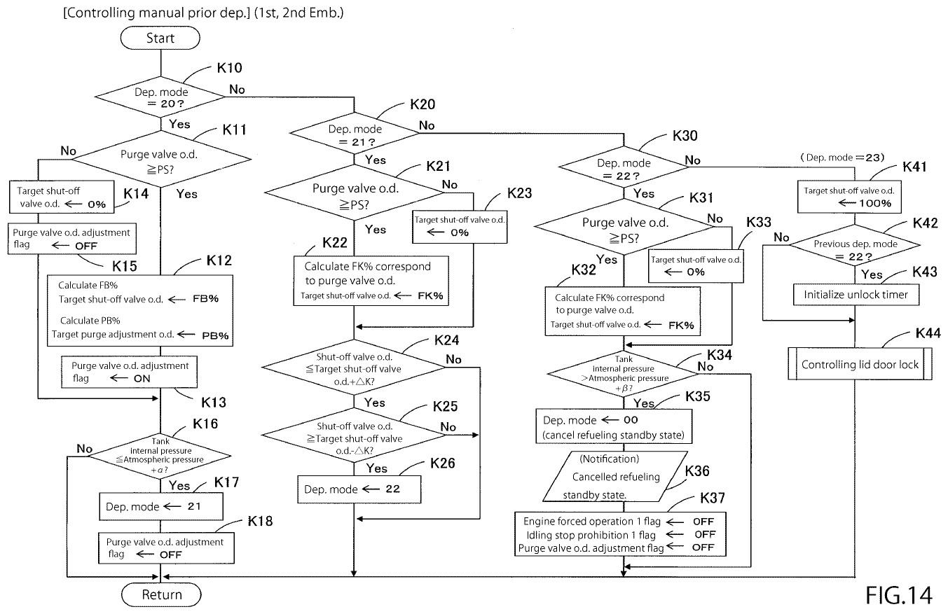

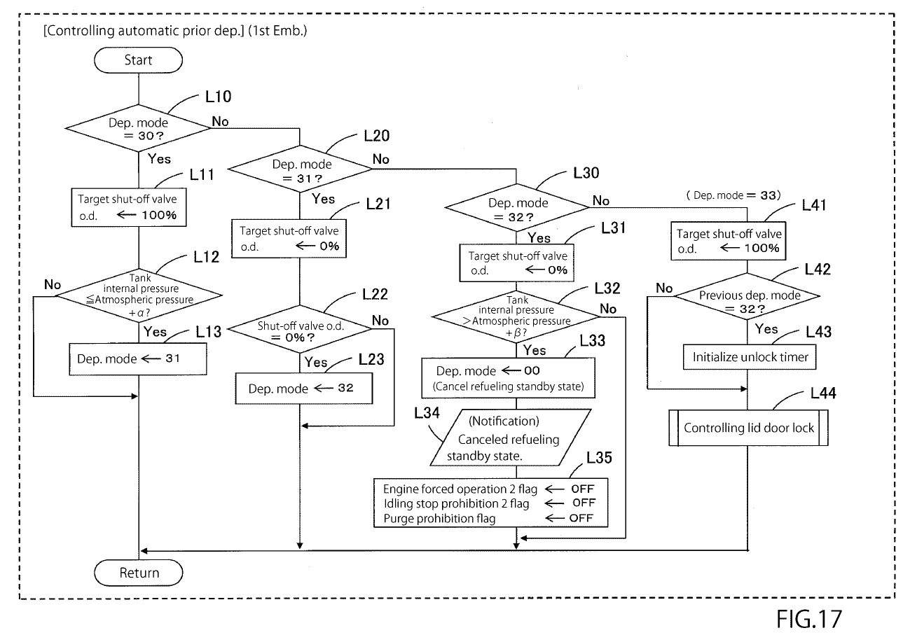

FIG. 13 is a flowchart explaining the details of the [Controlling lid door lock] at Step J44 in FIG. 12. The [Controlling lid door lock] at Step K44 in FIG. 14 and the [Controlling lid door lock] at step L44 in FIG. 17 are also the [Controlling lid door lock] in FIG. 13. The following explanation is an example of executing the [Controlling lid door lock] at Step J44 in FIG. 12. When executing the [Controlling lid door lock] at Step J44 in FIG. 12, processing is advanced to Step M10 of the [Controlling lid door lock] shown in FIG. 13.

At Step M10, the control unit 70 determines whether the unlocking timer is shorter than or equal to the unlocking time. The unlocking time is the duration for which the lid door remains unlocked, and is typically set to approximately 100 milliseconds to 1 second. If the unlocking timer is shorter than or equal to the unlocking time (Yes), processing is advanced to Step M11; otherwise (No), processing is advanced to Step M21.

If processing is advanced to Step M11, the control unit 70 energizes the unlocking device 52 (see the “energize” of the “unlocking device control signal” at time T15 in FIG. 19 and time T25 in FIG. 20), then processing is advanced to Step M12. When the control unit 70 energizes the unlocking device 52, the unlocking device 52 shown in FIG. 2 moves the movable pin 53 toward the pin position detection unit 54, and the lid door 50 is unlocked and opened.

At Step M12, the control unit 70 sets the lid door opening flag indicating that the lid door is in an open state to ON, then processing is advanced to Step M13.

At Step M13, the control unit 70 outputs a notification such as “The lid door has been opened” from the notification unit 31 (see time T15 in FIG. 19 and time T25 in FIG. 20), and terminates the processing shown in FIG. 13. Then, the control unit 70 returns the processing after Step J44 in FIG. 12.

When processing is advanced to Step M21, the control unit 70 stops energizing the unlocking device 52, then processing is advanced to Step M22.

At Step M22, the control unit 70 determines whether the lid door opening flag is ON. If the lid door opening flag is ON (Yes), processing is advanced to Step M23; otherwise (No), the control unit 70 terminates the processing shown in FIG. 13 and returns the processing after Step J44 in FIG. 12.

If processing is advanced to Step M23, the control unit 70 determines whether the lid door has been moved from the opened state to the closed state. In this case, the control unit 70 determines whether an ON signal has been output from the pin position detection unit 54 shown in FIGS. 2 and 3. If the pin position detection unit 54 outputs an “ON” signal (Yes), processing is advanced to Step M24; otherwise (No), the processing shown in FIG. 13 is terminated and the processing returns after Step J44 in FIG. 12.

If processing is advanced to Step M24, the control unit 70 sets the lid door opening flag to OFF (see time T16 in FIG. 19 and time T26 in FIG. 20), then processing is advanced to Step M25.

At Step M25, the control unit 70 outputs a notification such as “The lid door has been closed” from the notification unit 31 (see time T16 in FIG. 19 and time T26 in FIG. 20), then processing is advanced to Step M26.

At Step M26, the control unit 70 sets the depressurization mode to “00” (see time T16 in FIG. 19 and time T26 in FIG. 20), terminates the processing shown in FIG. 13, and returns the processing after Step J44 in FIG. 12. The control unit 70 sets the depressurization mode to “00” (returning it to a state where no depressurization control is being executed) because refueling is complete and the lid door is closed.

FIG. 14 is a flowchart explaining the details of the [Controlling manual prior depressurization] at Step H21 in FIG. 11. When executing the [Controlling manual prior depressurization] at Step H21 in FIG. 11, the control unit 70 proceeds to Step K10 of the [Controlling manual prior depressurization] shown in FIG. 14.

At Step K10, the control unit 70 determines whether the depressurization mode is “20.” If the depressurization mode is “20” (Yes), processing is advanced to Step K11; otherwise (No), processing is advanced to Step K20.

If processing is advanced to Step K11, the control unit 70 determines whether the purge valve opening degree is greater than or equal to the specified purge valve opening degree (PS %). (PS %) is set to an appropriate value confirmed through experiments using an actual vehicle or simulation, etc. If the purge valve opening degree is greater than or equal to the specified purge valve opening degree (PS %), processing is advanced to Step K12; otherwise (No), processing is advanced to Step K14.

If processing is advanced to Step K12, the control unit 70 calculates a target shut-off valve opening degree (FB %) and sets (FB %) as the target shut-off valve opening degree. The control unit 70 calculates a target purge adjustment opening degree (PB %) and sets (PB %) as the target purge adjustment opening degree, then processing is advanced to Step K13. For example, the control unit 70 has stored at least one of the [Target shut-off valve opening degree characteristic 1, Target purge adjustment opening degree characteristic 1], [Target shut-off valve opening degree characteristic 2, Target purge adjustment opening degree characteristic 2], and [Target shut-off valve opening degree characteristic 3, Target purge adjustment opening degree characteristic 3] shown in FIG. 15. The control unit 70 calculates the target shut-off valve opening degree (FB %) and the target purge adjustment opening degree (PB %) using the stored characteristics.

Regarding the [Target shut-off valve opening degree characteristic 1, Target purge adjustment opening degree characteristic 1], for example, the target shut-off valve opening degree (FB %) and the target purge adjustment opening degree (PB %) according to the tank internal pressure has set, and the target shut-off valve opening degree (FB %) and the target purge adjustment opening degree (PB %) are set to decrease as the tank internal pressure increases. The control unit 70 can adjust the opening degree of the shut-off valve according to the tank internal pressure.

Regarding the [Target shut-off valve opening degree characteristic 2, Target purge adjustment opening characteristic 2], for example, the target shut-off valve opening degree (FB %) and the target purge adjustment opening degree (PB %) based on the distance from the vehicle's position to the refueling facility has set, and the target shut-off valve opening degree (FB %) and the target purge adjustment opening degree (PB %) are set to decrease as the distance increases. The control unit 70 can adjust the opening degree of the shut-off valve according to the distance from the vehicle's position to the refueling facility.

Regarding the [Target shut-off valve opening degree characteristic 3, Target purge adjustment opening characteristic 3], for example, the target shut-off valve opening degree (FB %) and target purge adjustment opening degree (PB %) according to the estimated travel time from the vehicle's position to the refueling facility. The target shut-off valve opening degree (FB %) and the target purge adjustment opening degree (PB %) are set to decrease as the estimated required time increases. The control unit 70 can adjust the opening degree of the shut-off valve according to the estimated required time from the vehicle to the refueling facility.

The control unit 70 calculates the target shut-off valve opening degree (FB %) and the target purge adjustment opening degree (PB %) using at least one of the following: the [Target shut-off valve opening degree characteristic 1, Target purge adjustment opening degree characteristic 1], [Target shut-off valve opening degree characteristic 2, Target purge adjustment opening degree characteristic 2], and [Target shut-off valve opening degree characteristic 3, Target purge adjustment opening degree characteristic 3]. When using two or more, the maximum or minimum target shut-off valve opening degree (FB %) and the target purge adjustment opening degree (PB %) may be selected. Alternatively, the average value may be used as the target shut-off valve opening degree (FB %) and the target purge adjustment opening degree (PB %).

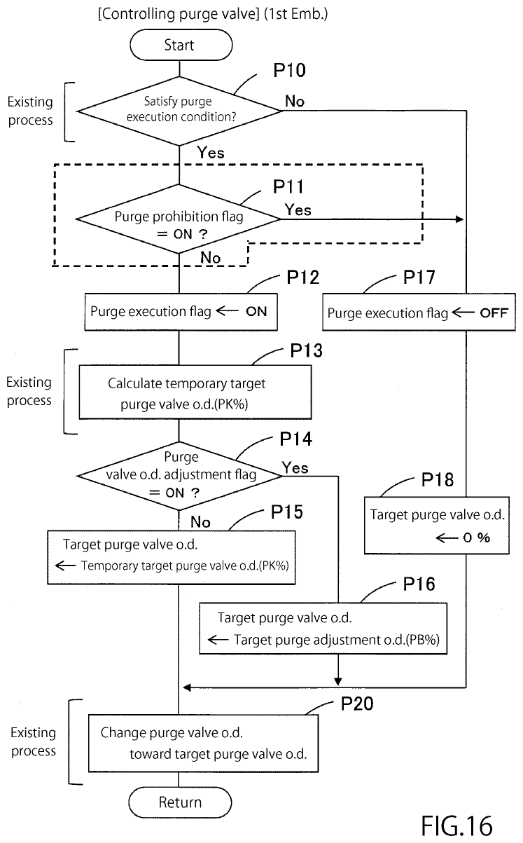

At Step K13, the control unit 70 sets the purge valve opening degree adjustment flag to ON, then processing is advanced to Step K16. The purge valve opening degree adjustment flag is used at Step P14 in FIG. 16 described below.

If processing is advanced to Step K14, the control unit 70 sets the target shut-off valve opening degree to 0%, then processing is advanced to Step K15. If the purge valve opening degree is less than the specified purge valve opening degree (PS %), the control unit 70 sets the shut-off valve opening degree to 0%.

At Step K15, the control unit 70 sets the purge valve opening degree adjustment flag to OFF, then processing is advanced to Step K16.

If processing is advanced to Step K16, the control unit 70 determines whether the tank internal pressure is less than or equal to (atmospheric pressure+α). The value of “α” is, for example, approximately 0.2 kPa. If the tank internal pressure is less than or equal to (atmospheric pressure+α) (Yes), processing is advanced to Step K17; otherwise (No), the processing shown in FIG. 14 is terminated, then processing returns after Step H21 in FIG. 11.

If processing is advanced to Step K17, the control unit 70 sets the depressurization mode to “21” (see time T34 in FIGS. 21 and 22), then processing is advanced to Step K18.

At Step K18, the control unit 70 sets the purge valve opening degree adjustment flag to OFF, terminates the processing shown in FIG. 14, and returns the processing after Step H21 in FIG. 11.

If processing is advanced to Step K20, the control unit 70 determines whether the depressurization mode is “21.” If the depressurization mode is “21” (Yes), processing is advanced to Step K21; otherwise (No), processing is advanced to Step K30.

If processing is advanced to Step K21, the control unit 70 determines whether the purge valve opening degree is greater than or equal to the specified purge valve opening degree (PS %). If the purge valve opening degree is greater than or equal to the specified purge valve opening degree (PS %) (Yes), processing is advanced to Step K22; otherwise (No), processing is advanced to Step K23.

If processing is advanced to Step K22, the control unit 70 calculates the target shut-off valve opening degree (FK %) corresponding to the purge valve opening degree, sets the target shut-off valve opening degree to (FK %), then processing is advanced to Step K24. For example, the control unit 70 calculate the target shut-off valve opening degree (FK %) based on the [Target shut-off valve opening degree characteristic 4] shown in FIG. 15, which is memorized in the control unit 70.

If the processing is advanced to Step K23, the control unit 70 sets the target shut-off valve opening degree to 0%, then processing is advanced to Step K24. At times T34 to T35 in FIGS. 21 and 22, since the target shut-off valve opening degree is set to (FK %), the shut-off valve opening degree is gradually changed toward (FK %).

When processing is advanced to Step K24, the control unit 70 determines whether the shut-off valve opening degree is less than or equal to (the target shut-off valve opening degree+ΔK). ΔK is a small pressure, and is set an appropriate value such as several kPa. If the control unit 70 determines that the valve opening degree is less than or equal to (the target shut-off valve opening degree+ΔK) (Yes), processing is advanced to Step K25; otherwise (No), the control unit 70 terminates the processing shown in FIG. 14 and returns after Step H21 in FIG. 11.

If processing is advanced to Step K25, the control unit 70 determines whether the shut-off valve opening degree is greater than or equal to (the target shut-off valve opening degree−ΔK). If the shut-off valve opening degree is greater than or equal to (the target shut-off valve opening degree−ΔK) (Yes), processing is advanced to Step K26; otherwise (No), the control unit 70 terminates the processing shown in FIG. 14 and returns after Step H21 in FIG. 11. At Steps K24 and K25, the control unit 70 determines that the shut-off valve opening degree is approximately equal to the target shut-off valve opening degree if the target shut-off valve opening degree is within the range of (the target shut-off valve opening degree−ΔK) to (the target shut-off valve opening degree+ΔK), then processing is advanced to Step K26.

If processing is advanced to Step K26, the control unit 70 sets the depressurization mode to “22” (see time T35 in FIGS. 21 and 22), terminates the processing shown in FIG. 14, and returns the processing after Step H21 in FIG. 11.

If processing is advanced to Step K30, the control unit 70 determines whether the depressurization mode is “22.” If the depressurization mode is “22” (Yes), processing is advanced to Step K31; otherwise (No), processing is advanced to Step K41.

If processing is advanced to Step K31, the control unit 70 determines whether the purge valve opening degree is greater than or equal to the specified purge valve opening degree (PS %). If the purge valve opening degree is greater than or equal to the specified purge valve opening degree (PS %) (Yes), processing is advanced to Step K32; otherwise (No), processing is advanced to Step K33.

If processing is advanced to Step K32, the control unit 70 calculates the target shut-off valve opening degree (FK %) corresponding to the purge valve opening degree, sets the target shut-off valve opening degree to (FK %) (see times T35 to T36 in FIGS. 21 and 22), and proceeds to Step K34. For example, the target shut-off valve opening degree (FK %) is calculated based on the [Target shut-off valve opening degree characteristic 4] shown in FIG. 15, which is stored in the control unit 70.

If processing is advanced to Step K33, the control unit 70 sets the target valve opening degree to 0%, then processing is advanced to Step K34.

When processing is advanced to Step K34, the control unit 70 determines whether the tank internal pressure is higher than (atmospheric pressure+β). The value of “β” is, for example, approximately 5 kPa. If the tank internal pressure is higher than (atmospheric pressure+β) (Yes), processing is advanced to Step K35; otherwise (No), the processing shown in FIG. 14 is terminated, and the processing returns after Step H21 in FIG. 11.

If processing is advanced to Step K35, the control unit 70 sets the depressurization mode to “00”, then processing is advanced to Step K36. If the depressurization mode is “22” (the refueling standby state where manual prior depressurization is complete and waiting for lid door switch operation), and the tank internal pressure rises while no operation of the lid door switch is executed by the user, the refueling standby state is canceled.

At Step K36, the control unit 70 outputs a notification such as “Refueling standby state canceled” from the notification unit 31, then processing is advanced to Step K37.

At Step K37, the control unit 70 sets the engine forced operation 1 flag, the idling stop prohibition 1 flag, and the purge valve opening degree adjustment flag to OFF, terminates the processing shown in FIG. 14, and returns the processing after Step H21 in FIG. 11.

If processing is advanced to Step K41 (in this case, the depressurization mode is “23”), the control unit 70 sets the target shut-off valve opening degree to 100% (see time T37 to T38 in FIG. 21), then processing is advanced to Step K42.

At Step K42, the control unit 70 determines whether the prior depressurization mode was “22.” If the prior depressurization mode was “22” (Yes), processing is advanced to Step K43; otherwise (No), processing is advanced to Step K44.

If processing is advanced to Step K43, the control unit 70 initializes (resets to zero) the unlocking timer and proceeds to Step K44. The control unit 70 initializes the unlocking timer at the timing when the depressurization mode changes from “22” to “23” (the timing when the lid door switch is operated to open the lid door from the manual prior depressurization completion state).

If processing is advanced to Step K44, the control unit 70 executes [Controlling lid door lock] to terminate the processing shown in FIG. 14 and returns processing after Step H21 in FIG. 11. Details of [Controlling lid door lock] have already been explained with reference to FIG. 13.

FIG. 16 is a flowchart explaining the purge valve control in which the control unit 70 controls the opening degree of the purge valve 62. The control unit 70 starts the [Controlling purge valve] shown in FIG. 16 at specified time intervals (several minutes to several tens of minutes intervals), then processing is advanced to step P10.

At Step P10, the control unit 70 determines whether the purge execution conditions are satisfied. Since Step P10 is an existing process, details of the purge execution conditions are omitted. If the purge execution conditions are satisfied (Yes), processing is advanced to Step P11; otherwise (No), processing is advanced to Step P17.

If processing is advanced to Step P11, the control unit 70 determines whether the purge prohibition flag is ON. The purge prohibition flag is a flag set to ON at Step A68 in FIG. 4. If the purge prohibition flag is ON (Yes), processing is advanced to Step P17; otherwise (No), processing is advanced to Step P12.

If processing is advanced to Step P12, the control unit 70 sets the purge execution flag to ON, then processing is advanced to Step P13.

At Step P13, the control unit 70 calculates the temporary target purge valve opening degree (PK %) based on the engine operating condition, then processing is advanced to Step P14. Since the processing at Step P13 is existing processing, details are omitted.

At Step P14, the control unit 70 determines whether the purge valve opening degree adjustment flag is ON. If the purge valve opening degree adjustment flag is ON (Yes), processing is advanced to Step P16; otherwise (No), processing is advanced to Step P15. The purge valve opening degree adjustment flag is the flag set to ON at Step K13 in FIG. 14.

If processing is advanced to Step P15, the control unit 70 sets the temporary target purge valve opening degree (PK %) as the target purge valve opening degree and proceeds to Step P20. The temporary target purge valve opening degree (PK %) is obtained at Step P13. Times T34 to T36 in FIGS. 21 and 22 show an example where the target purge valve opening degree is set to (PK %).

If processing is advanced to Step P16, the control unit 70 sets the target purge adjustment opening degree (PB %) as the target purge valve opening degree and proceeds to Step P20. The target purge adjustment opening degree (PB %) is obtained at Step K12 in FIG. 14. Times T32 to T34 in FIGS. 21 and 22 show an example where the target purge valve opening degree is set to (PB %).

If processing is advanced to Step P17, the control unit 70 sets the purge execution flag to OFF and proceeds to Step P18.

At Step P18, the control unit 70 sets the target purge valve opening degree to 0% and proceeds to Step P20.

If processing is advanced to Step P20, the control unit 70 controls the purge valve opening degree to gradually change it so that it approaches the target purge valve opening degree, and terminates the processing shown in FIG. 16. The processing of Step

### P20 Is Existing Processing.

FIG. 17 is a flowchart explaining the details of the [Controlling automatic prior depressurization] at Step H31 in FIG. 11. When executing the [Controlling automatic prior depressurization] at Step H31 in FIG. 11, processing is advanced to Step L10 of the [Controlling automatic prior depressurization] shown in FIG. 17.

At Step L10, the control unit 70 determines whether the depressurization mode is “30.” If the depressurization mode is “30” (Yes), processing is advanced to Step L11; otherwise (No), processing is advanced to Step L20.

If processing is advanced to Step L11, the control unit 70 sets the target shut-off valve opening degree to 100% (see time T54 to time T55 in FIG. 23), then processing is advanced to Step L12.

If processing is advanced to Step L12, the control unit 70 determines whether the tank internal pressure is less than or equal to (atmospheric pressure+α). The value of “α” is, for example, approximately 0.2kPa. If the tank internal pressure is less than or equal to (atmospheric pressure+α) (Yes), processing is advanced to Step L13; otherwise (No), the processing shown in FIG. 17 is terminated, and returns after Step H31 in FIG. 11.

If processing is advanced to Step L13, the control unit 70 sets the depressurization mode to “31” (see time T55 in FIG. 23), terminates the processing shown in FIG. 17, and returns the processing after Step H31 in FIG. 11.

If processing is advanced to Step L20, the control unit 70 determines whether the depressurization mode is “31.” If the depressurization mode is “31” (Yes), processing is advanced to Step L21; otherwise (No), processing is advanced to Step L30.

If processing is advanced to Step L21, the control unit 70 sets the target shut-off valve opening degree to 0% (see time T55 to T56 in FIG. 23), then processing is advanced to Step L22.

At Step L22, the control unit 70 determines whether the shut-off valve opening degree is 0%. If the shut-off valve opening degree is 0% (Yes), processing is advanced to Step L23; otherwise (No), the control unit 70 terminates the processing shown in FIG. 17 and returns the processing after Step H31 in FIG. 11.

If processing is advanced to Step L23, the control unit 70 sets the depressurization mode to “32” (see time T56 in FIG. 23), terminates the processing shown in FIG. 17, and returns the processing after Step H31 in FIG. 11.

If processing is advanced to Step L30, the control unit 70 determines whether the depressurization mode is “32.” If the depressurization mode is “32” (Yes), processing is advanced to Step L31; otherwise (No), processing is advanced to Step L41.

If processing is advanced to Step L31, the control unit 70 sets the target shut-off valve opening degree to 0% (see time T56 to T58 in FIG. 23), then processing is advanced to Step L32.

At Step L32, the control unit 70 determines whether the tank pressure is higher than (atmospheric pressure+β). The value of “β” is, for example, approximately 5kPa. If the tank internal pressure is higher than (atmospheric pressure+β) (Yes), processing is advanced to Step L33; otherwise (No), the processing shown in FIG. 17 is terminated, and returns after Step H31 in FIG. 11.

If processing is advanced to Step L33, the control unit 70 sets the depressurization mode to “00”, then processing is advanced to Step L34. If the depressurization mode is “32” (in refueling standby state where automatic prior depressurization is complete and waiting for lid door switch operation), and the tank internal pressure continues to rise without the user operating the lid door switch, the control unit 70 cancels the refueling standby state.

At Step L34, the control unit 70 outputs a notification such as “Refueling standby state is canceled” from the notification unit 31, then processing is advanced to Step L35.

At Step L35, the control unit 70 sets the engine forced operation 2 flag, the idling stop prohibition 2 flag, and the purge prohibition flag to OFF, respectively. Then, the processing shown in FIG. 17 is terminated, and returns after Step H31 in FIG. 11.

If processing is advanced to Step L41 (the depressurization mode is “33”), the control unit 70 sets the target shut-off valve opening degree to 100% (see time T58 to T59 in FIG. 23), then processing is advanced to Step L42.

At Step L42, the control unit 70 determines whether the previous depressurization mode is “32.” If the previous depressurization mode is “32” (Yes), processing is advanced to Step L43; otherwise (No), processing is advanced to Step L44.

If processing is advanced to Step L43, the control unit 70 initializes (resets to zero) the unlocking timer, then processing is advanced to Step L44. The control unit 70 initializes the unlocking timer at the timing when the depressurization mode changes from “32” to “33” (i.e., the timing when the user operates the lid door switch and opens the lid door from the automatic prior depressurization completion state).

If processing is advanced to Step L44, the control unit 70 executes the [Controlling lid door lock], terminates the processing shown in FIG. 17, and returns processing after Step H31 in FIG. 11. Details of the [Controlling lid door lock] have already been explained with reference to FIG. 13.

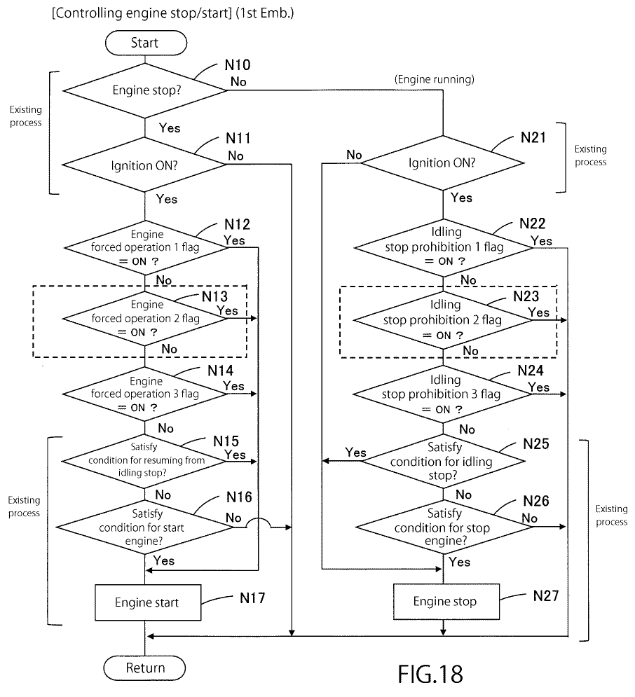

FIG. 18 is a flowchart explaining the control executed by the control unit 70 to stop or start (operate) the engine. The control unit 70 starts the [Controlling engine stop/start] shown in FIG. 18 at specified time intervals (several minutes to several tens of minutes intervals), then processing is advanced to Step N10.

At Step N10, the control unit 70 determines whether the engine is stopped. If the engine is stopped (Yes), processing is advanced to Step N11; otherwise (No), processing is advanced to Step N21.

If processing is advanced to Step N11, the control unit 70 determines whether the ignition is ON. If the ignition is ON (Yes), processing is advanced to Step N12; otherwise (No), the processing shown in FIG. 18 is terminated.

If processing is advanced to Step N12, the control unit 70 determines whether the engine forced operation 1 flag is ON. If the engine forced operation 1 flag is ON (Yes), processing is advanced to Step N17; otherwise (No), processing is advanced to Step N13.

If processing is advanced to Step N13, the control unit 70 determines whether the engine forced operation 2 flag is ON. If the engine forced operation 2 flag is ON (Yes), processing is advanced to Step N17; otherwise (No), processing is advanced to Step N14.

If processing is advanced to Step N14, the control unit 70 determines whether the engine forced operation 3 flag is ON. If the engine forced operation 3 flag is ON (Yes), processing is advanced to Step N17; otherwise (No), processing is advanced to Step N15.

If processing is advanced to Step N15, the control unit 70 determines whether the conditions for resuming from idling stop are satisfied. Since Step N15 is an existing process, details of the conditions for resuming from idling stop are omitted. If the conditions for resuming from idling stop are satisfied (Yes), processing is advanced to Step N17; otherwise (No), processing is advanced to Step N16.

If processing is advanced to Step N16, the control unit 70 determines whether other conditions for starting the engine are satisfied. Since Step N16 is an existing process, details of other conditions for starting the engine are omitted. If the control unit 70 determines that other conditions for starting the engine are satisfied (Yes), processing is advanced to Step N17; otherwise (No), the control unit 70 terminates the processing shown in FIG. 18.

If processing is advanced to Step N17, the control unit 70 starts the engine to bring it into an operating state and terminates the processing shown in FIG. 18. Since Step N17 is an existing process, details of starting the engine are omitted.

If processing is advanced to Step N21, the control unit 70 determines whether the ignition is ON. If the ignition is ON (Yes), processing is advanced to Step N22; otherwise (No), processing is advanced to Step N27.

If processing is advanced to Step N22, the control unit 70 determines whether the idling stop prohibition 1 flag is ON. If the idling stop prohibition 1 flag is ON (Yes), the control unit 70 terminates the processing shown in FIG. 18; otherwise (No), processing is advanced to Step N23.

If processing is advanced to Step N23, the control unit 70 determines whether the idling stop prohibition 2 flag is ON. If the idling stop prohibition 2 flag is ON (Yes), the control unit 70 terminates the processing shown in FIG. 18; otherwise (No), processing is advanced to Step N24.

If processing is advanced to Step N24, the control unit 70 determines whether the idling stop prohibition 3 flag is ON. If the idling stop prohibition 3 flag is ON (Yes), the control unit 70 terminates the processing shown in FIG. 18; otherwise (No), processing is advanced to Step N25.

If processing is advanced to Step N25, the control unit 70 determines whether the conditions for idling stop are satisfied. Since Step N25 is an existing process, details of the conditions for idling stop condition are omitted. If the conditions for idling stop are satisfied (Yes), processing is advanced to Step N27; otherwise (No), processing is advanced to Step N26.

If processing is advanced Step N26, the control unit 70 determines whether other conditions for engine stop are satisfied. Since Step N26 is an existing process, details of the other conditions for engine stop are omitted. If the other conditions for engine stop are satisfied (Yes), processing is advanced to Step N27; otherwise (No), the processing shown in FIG. 18 is terminated.

If processing is advanced to Step N27, the control unit 70 stops the engine and terminates the processing shown in FIG. 18. Since Step N27 is an existing process, details of stopping the engine are omitted.

Note that if the vehicle does not have an idling stop function, Steps N15, N22 to N25 may be omitted.

Next, [Motion waveform example 1-1] and [Motion waveform example 1-2] of the “Controlling general depressurization” executed by the processing of the control unit 70 described above will be described with reference to FIGS. 19 and 20. FIG. 19 shows an example of the motion waveform when the user presses the lid door switch immediately before entering the refueling facility to start the “Controlling general depressurization” from the engine stopped state (for PHEVs and HEVs). FIG. 20 shows an example of the motion waveform when the user presses the lid door switch immediately before entering the refueling facility to start the “Controlling general depressurization” from the engine running state.

In FIG. 19, the engine is in stopped state (for PHEVs and HEVs) immediately before time T12. In FIG. 20, the engine is in running state immediately before time T22. Before time T12 in FIG. 19 (time T22 in FIG. 20), the vehicle has not yet entered the refueling facility, so the notification at Step C32 in FIG. 6 is executed.

At time T12 in FIG. 19 (time T22 in FIG. 20), the user has pressed the lid door switch, not the pre-refueling switch, immediately before entering the refueling facility. Therefore, the control unit 70 sets the depressurization mode to “10” (the general depressurization in progress state) at Step A45 in FIG. 4 and starts “Controlling general depressurization.” Furthermore, the control unit sets the target shut-off valve opening degree to FA % at Step J11 in FIG. 12 and controls the shut-off valve opening degree toward FA %. Therefore, depressurization in the tank internal pressure starts. The user enters the refueling facility at time T1N in FIG. 19 (time T2N in FIG. 20), then turns off the ignition at time T1M in FIG. 19 (time T2M in FIG. 20).

At time T13 in FIG. 19 (time T23 in FIG. 20), the control unit 70 determines that the tank internal pressure has fallen below (atmospheric pressure+α). Therefore, the control unit 70 sets the depressurization mode to “11” (the general depressurization completion preparation state) at Step J13 in FIG. 12. Furthermore, the control unit 70 sets the target shut-off valve opening degree to 100% at Step J21 in FIG. 12 and controls the shut-off valve opening degree toward 100%. Therefore, between time T13 and T14 in FIG. 19 (between time T23 and T24 in FIG. 20), the tank internal pressure decreases to atmospheric pressure.

At time T14 in FIG. 19 (time T24 in FIG. 20), the shut-off valve opening degree has reached to 100% (the target shut-off valve opening degree has reached to 100%), the control unit 70 sets the depressurization mode to “12” (the general depressurization complete state) at Step J23 in FIG. 12, and set the target shut-off valve opening degree to 100% at Step J31 in FIG. 12.

At time T15 in FIG. 19 (time T25 in FIG. 20), the depressurization mode is set to “12”. Therefore, the control unit 70 sets the depressurization mode to “13” (the lid door open state) at Step D12 in FIG. 7. Furthermore, the control unit 70 executes power supply to the unlocking device at Step M11 in FIG. 13 transferred from Step J44 in FIG. 12 to unlock and open the lid door. The user can refuel during the period from time T15 to T16 in FIG. 19 (time T25 to T26 in FIG. 20).

At time T16 in FIG. 19 (time T26 in FIG. 20), the control unit 70 detects that the user has closed the lid door since the movable pin detection signal is input (ON) when the lid door opening flag is ON. Then, the lid door opening flag is set to OFF at Step M24 in FIG. 13 transferred from Step J44 in FIG. 12, then the depressurization mode is set to “00” at Step M26.

Next, [Motion waveform example 2-1] of “Controlling manual prior depressurization” executed by the processing of the control unit 70 described above will be described with reference to FIG. 21. FIG. 21 shows the motion waveform when the user presses the pre-refueling switch to start “Controlling manual prior depressurization” from a state where the ignition is ON and the engine is stopped (for PHEVs and HEVs) before entering the refueling facility.

At time T31 in FIG. 21, the user pressed the pre-refueling switch before entering the refueling facility while driving the vehicle. Therefore, the control unit 70 set the depressurization mode to “20” (the manual prior depressurization state) at Step A56 in FIG. 4 and started “Controlling manual prior depressurization control.” The control unit 70 then sets the engine forced start 1 flag and the idling stop prohibition 1 flag to ON to start the engine. In the “Controlling manual prior depressurization,” the valve opening degree of the shut-off valve remains at 0% until the engine is in the running state and the purge valve opening degree reaches (PS %) or more (Step K11 to K13 in FIG. 14).

At time T32 in FIG. 21, the engine is put into an operating state, the purge execution flag is turned ON, and purge control is started (the purge valve opening degree is gradually increasing from 0%).

At time T33 in FIG. 21, since the purge valve opening degree has reached (PS %) or more, the control unit 70 sets the target purge adjustment opening degree to (PB %) and the target shut-off valve opening degree to (FB %) at Steps K11 and K12 in FIG. 14. Therefore, the depressurization in the tank starts. As shown in FIG. 15, the lower the tank internal pressure, or the shorter the distance from the vehicle's position to the refueling facility, or the shorter the estimated time required to travel from the vehicle's position to the refueling facility, the larger the target purge adjustment opening degree PB % and the target shut-off valve opening degree FB % are set to. At time T33 to T34 in FIG. 21, the vehicle gradually approaches the refueling facility, so the target shut-off valve opening degree FB % gradually increases.

At time T34 in FIG. 21, the tank internal pressure has fallen below (atmospheric pressure+α), so the control unit 70 sets the pressure reduction mode to “21” (the manual prior depressurization completion preparation state) at step K17 in FIG. 14. Furthermore, the control unit 70 sets the target shut-off valve opening degree to (FK %) at step K22 in FIG. 14, and controls the shut-off valve opening degree toward (FK %).

At time T35 in FIG. 21, since the control unit 70 determined that (the target shut-off valve opening degree FK %+ΔK )≥(the shut-off valve opening degree) ≥(the target shut-off valve opening degree FK %−ΔK %), the control unit 70 set the depressurization mode to “22” (the manual prior depressurization complete state) at Step K26 in FIG. 14. The user has entered into the refueling facility at time T3N in FIG. 21.

At time T36 in FIG. 21, the user turns the ignition OFF. The control unit 70 stops the engine, sets the target shut-off valve opening degree to 0% at Step K33 in FIG. 14, and controls the shut-off valve opening degree toward 0%. When the depressurization mode is “22,” the control unit 70 enters the refueling standby state, waiting for the lid door switch to be pressed by the user.

At time T37 in FIG. 21, the control unit 70 sets the depressurization mode to “23” (the lid door open state) at Step E14 in FIG. 8 since the user pressed the lid door switch. The control unit 70 sets the target shut-off valve opening degree to 100% at Step K41 in FIG. 14 and controls the shut-off valve opening degree toward 100%. Therefore, the tank internal pressure is reduced to atmospheric pressure. Furthermore, the control unit 70 performs power supply to the unlocking device Step M11 in FIG. 13 transferred from Step M44 in FIG. 14 to unlock and open the lid door. The user can refuel during the period from time T37 to T38 in FIG. 21.

At time T38 in FIG. 21, the control unit 70 detects that the user has closed the lid door because the movable pin detection signal is input (ON) when the lid door opening flag is ON. Therefore, the control unit 70 sets the lid door opening flag to OFF at Step M24 in FIG. 13 transferred from Step K44 in FIG. 14, then set the depressurization mode to “00” at Step M26.

Next, [Motion waveform example 2-2] of the “Controlling manual prior depressurization” executed by the control unit 70 will be described with reference to FIG. 22. FIG. 22 is the same as FIG. 21 from time T31 to T36. After time T36, the example shows a case where the user performs a cancellation operation by pressing the pre-refueling switch twice.

At time T35 in FIG. 22, the control unit 70 sets the depressurization mode to “22” (the manual prior depressurization complete state) as described in FIG. 21, and enters the refueling standby state, waiting for the user to press the lid door switch.

At time T3A to T3B in FIG. 22, the user performed the cancellation operation (pressing the pre-refueling switch twice) to cancel the refueling standby state. Therefore, the control unit 70 sets the depressurization mode to “00” at Step G23 of FIG. 9 transferred from Step E16 in FIG. 8.

Next, [Motion waveform example 3-1] of the “Controlling automatic prior depressurization” executed by the control unit 70 will be described with reference to FIG. 23. FIG. 23 shows the motion waveform when the “automatic prior depressurization control” is automatically started when the vehicle enters the refueling facility while the ignition is ON and the user has not pressed either the pre-refueling switch or the lid door switch.

At time T51 in FIG. 23, the vehicle entered the refueling facility without pressing either the pre-refueling switch or the lid door switch. However, from time T51 to T54, the vapor concentration in the canister is greater than or equal to the specified vapor concentration (VS %). Therefore, the execution condition B (canister vapor concentration ≥specified vapor concentration (VS %), and ignition ON) at Step A64 in FIG. 4 is satisfied. Consequently, the engine forced operation 2 flag and the idling stop prohibition 2 flag are set to ON, vapor concentration reduction is executed, and the depressurization mode remains at “00.” During the time period from time T51 to T54 in FIG. 23, the notification of Step A66 in FIG. 4 is executed. Before time T51 in FIG. 23, since the vehicle has not yet entered the refueling facility, the notification of Step C32 in FIG. 6 is executed.

At time T54 in FIG. 23, since the vapor concentration became less than (VS %), the control unit 70 sets the depressurization mode to “30” (the automatic prior depressurization state) at Step A69 in FIG. 4, then starts the “Controlling automatic prior depressurization”. The control unit 70 sets the purge prohibition flag to ON at Step A68 in FIG. 4, sets the shut-off valve target opening degree to 100% at Step L11 in FIG. 17, and controls the shut-off valve opening degree toward 100%.

At time T55 in FIG. 23, since the tank internal pressure is less than or equal to (atmospheric pressure+α), the control unit 70 sets the depressurization mode to “31” (the automatic prior depressurization complete preparation state) at Step L13 in FIG. 17. Further, the control unit 70 sets the target shut-off valve opening degree to 0% at Step L21 in FIG. 17 and controls the shut-off valve opening degree toward 0%.

The shut-off valve opening degree became 0% (the target shut-off valve opening degree reached 0%) at time T56 in FIG. 23. Therefore, the control unit 70 sets the depressurization mode to “32” (the automatic prior depressurization complete state) at Step L23 in FIG. 17.

At time T57 in FIG. 23, the user turned the ignition OFF. The control unit 70 stops the engine, sets the target shut-off valve opening degree to 0% at Step L31 in FIG. 17, and controls the shut-off valve opening degree toward 0%. If the depressurization mode is “32,” the control unit 70 becomes the fuel supply standby state, waiting for the lid door switch to be pressed by the user.

At time T58 in FIG. 23, the user pressed the lid door switch. Therefore, the control unit 70 sets the depressurization mode to “33” (the lid door open state) at Step F15 in FIG. 10. The control unit 70 sets the target shut-off valve opening degree to 100% at Step L41 in FIG. 17 and controls the shut-off valve opening degree toward 100%. Therefore, the tank internal pressure is reduced to atmospheric pressure. Furthermore, the control unit 70 performs power supply to the unlocking device at Step M11 in FIG. 13 transferred from Step L44 in FIG. 17, then unlock and open the lid door. The user can refuel during the period from time T58 to T59 in FIG. 23.

At time T59 in FIG. 23, the control unit 70 detects that the user has closed the lid door since the movable pin detection signal is input (ON) when the lid door opening flag is ON. Then, the lid door opening flag is set to OFF at Step M24 of FIG. 13 transferred from Step L44 of FIG. 17, then the depressurization mode is set to “00” at Step M26.

Examples of the operation of depressurization control in various cases will be described.
(1) When the pre-refueling switch (the pre-refueling operation unit 42) is pressed, the “manual prior depressurization control” is executed, and the system becomes the refueling standby state (depressurization mode=“22”), waiting for the lid door switch (the lid door operation unit 41) to be pressed. In this state, if the cancellation time has elapsed, an alert is issued to confirm the user's intention (Step S G20 to Step G21 in FIG. 9).
(2) If the lid door switch is pressed multiple times in a brief period, the control unit recognizes it as a single press (refer to the lid registration flag) as shown in FIG. 5. Based on the recognition, if the “Controlling general depressurization” is started, even if the lid door switch or pre-refueling switch is pressed during the execution of the “Controlling general depressurization,” no new depressurization control starts, and the currently executing “Controlling general depressurization” will continue (Step A10 and Step A12 in FIG. 4). Similarly, if the pre-refueling switch is pressed multiple times in a brief period, the control unit recognizes it as a single press (refer to the pre-registration flag) as shown in FIG. 5. Based on the recognition, if the “Controlling manual prior depressurization” is started, even if the lid door switch or pre-refueling switch is pressed during the execution of the “Controlling manual prior depressurization” is started, no new depressurization control starts, and the currently executing “Controlling manual prior depressurization” will continue (see Step A20 and Step A22 in FIG. 4).
(3) Even when purge control is not established, if the pre-refueling switch is pressed, the control unit accepts the “Controlling manual prior depressurization” instruction. If the “Controlling manual prior depressurization” instruction is accepted, the engine is started (and the idling stop function is inhibited) to execute purge control, and the shut-off valve is opened while purge control is being executed. Then, the tank internal pressure is depressurized without increasing the vapor concentration in the canister (time T31 to T34 in FIG. 21).
(4) If the vehicle enters the refueling facility while “Controlling manual prior depressurization” is being executed (when the depressurization mode is “20” or “21”), cancel “Controlling manual prior depressurization” and prompt the user to press the lid door switch (Step E23, Step E25 to E26 in FIG. 8).
(5) After transitioning to the refueling standby state where the control unit executes “Controlling manual prior depressurization” or “Controlling automatic prior depressurization” and waits for the user to press the lid door switch, if the user no longer intends to refuel for any reason and the vehicle remains stationary or in motion for an extended period, cancel the refueling standby state at Step G10 to Step G16 in FIG. 9.
(6) If the user mistakenly presses the pre-refueling switch instead of the lid door switch in the state where the vehicle is in the refueling facility without pressing the pre-refueling switch or the lid door switch and without executing any pressure reduction control, the control unit prompts the user to press the lid door switch at Step C10 to C12 and Step C40 in FIG. 6, and does not start “Controlling manual prior depressurization” (Step A52 in FIG. 4).
(7) In the “Controlling manual prior depressurization,” if the tank internal pressure is greater than (atmospheric pressure+β) and the fuel remaining amount is less than t or equal to he specified remaining amount at the start of depressurization, the depressurization mode is set to “20” and depressurization starts (the execution condition A of Step A54 in FIG. 4).
(8) In the “Controlling automatic prior depressurization,” if the tank internal pressure is greater than (atmospheric pressure+β) and the fuel remaining amount is less than or equal to the specified remaining amount at the start of depressurization, the depressurization mode is set to “30” and depressurization starts (the execution condition C of Step A67 in FIG. 4).
(9) If the vehicle is within a specified range (at least one of the distance or estimated travel time is within the specified range) from the refueling facility (or history position where pre-refueling operation was executed), use the notification unit to notify at least one of the following: the operation status of the pre-refueling switch, the depressurization status of the fuel tank based on the operation of the pre-refueling switch, or whether there is an intention to fuel (Step C20 to C34 in FIG. 6).
(10) If the notification described in (9) is executed, the notification unit 31 does not execute the notification again until the re-notification time has elapsed (Step C30 to C34 in FIG. 6).
(11) The control unit learns and stores the location of the refueling facility where the user has refueled, and if the vehicle is within a specified range of the refueling facility, the control unit may use the notification unit to notify the user of at least one of the following: the operation status of the pre-refueling switch, the depressurization state of the fuel tank based on the pre-refueling switch operation, or whether the user intends to refuel (Step C20, Steps C30 to C34 in FIG. 6). It may also be configured to learn and use refueling facility locations used a specified number of times.
(12) The control unit learns and stores the location where the user pressed the pre-refueling switch (the pre-refueling operation history position), and if the vehicle is near the pre-refueling operation history position, the control unit may use the notification unit to notify the user of at least one of the following: the operation status of the pre-refueling switch, the depressurization status of the fuel tank based on the pre-refueling switch operation, or whether the user intends to refuel (Step C21, C30 to C34 in FIG. 6). It may be configured to learn and use the location where the pre-refueling switch is pressed for a specified number of times as the pre-refueling operation history position.
(13) If the depressurization mode is not “00,” one of the depressurization controls (Controlling general depressurization, Controlling manual prior depressurization, or Controlling automatic prior depressurization) is being executed. Therefore, the notifications described in (9) to (12) are not executed (Step C10 in FIG. 6).
(14) Executed the “Controlling manual prior depressurization” to set the depressurization mode to “22” (the manual prior depressurization complete state), and transition to the refueling standby state, if the state where the user does not press the lid door switch and the tank internal pressure exceeds (atmospheric pressure+β), the control unit cancel the refueling standby state and set the depressurization mode to “00” (Step K34 to K37 in FIG. 14).
(15) Executed the “Controlling automatic prior depressurization” to set the depressurization mode to “32” (the automatic prior depressurization complete state), and transition to the refueling standby state, if the state where the user does not press the lid door switch and the tank internal pressure exceeds (atmospheric pressure+β), the control unit cancel the refueling standby state and set the depressurization mode to “00” (Step S L32 to L35 in FIG. 17).
(16) In the “Controlling manual prior depressurization,” if the distance from the vehicle's position to the refueling facility (or the pre-refueling operation history position) is far, set the target purge adjustment opening degree PB % and the target shut-off valve opening degree FB % to small values. If the distance from the vehicle's position to the refueling facility (or pre-refueling operation history position) is short, set the target purge adjustment opening degree PB % and the target shut-off valve opening degree FB % to larger values (Step K12 in FIG. 14, FIG. 15). Similarly, in “Controlling manual prior depressurization,” if the estimated required time from the vehicle's position to the refueling facility (or the pre-refueling operation history position) is long, set the target purge adjustment opening degree PB % and the target shut-off valve opening degree FB % to small values. If the estimated required time from the vehicle's position to the refueling facility (or the pre-refueling operation history location) is short, set the target purge adjustment opening degree PB % and the target shut-off valve opening degree FB % to larger values (Step K12 in FIG. 14, FIG. 15).
(17) If the vehicle enters the refueling facility with neither the lid door switch nor the pre-refueling switch pressed, set the purge prohibition flag to ON and start “Controlling automatic prior depressurization” (Step A68 and A69 in FIG. 4). During the execution of “Controlling automatic prior depressurization” (depressurization mode is “30”), purge control is prohibited, the shut-off valve is fully opened, and depressurization is executed in a brief time (time T54 to T55 in FIG. 23).
(18) After executing either “Controlling manual prior decompression” or “Controlling automatic prior decompression” and completing decompression to transition to the refueling standby state, if the lid door switch is not pressed by the user even after the cancellation confirmation time has elapsed, the notification unit issues an alert to inquire whether the user intends to proceed with refueling or cancel (Step E16 in FIG. 8, Step F17 in FIG. 10, Steps G20 and G21 in FIG. 9). If the user cancels refueling, set the engine forced operation 3 flag and the idling stop prohibition 3 flag to ON to reduce the vapor concentration inside the canister. This causes the engine to start, opening the purge valve and the shut-off valve to reduce the vapor concentration inside the canister (Steps G22 to G26 in FIG. 9).
(19) When the vehicle enters the refueling facility with neither the lid door switch nor the pre-refueling switch pressed, if the vapor concentration inside the canister is greater than or equal to VS %, the engine forced operation 2 flag and the idling stop prohibition 2 flag are set to ON without starting “Controlling automatic prior depressurization.” This causes the engine to start, open the purge valve and the shut-off valve, and reduce the vapor concentration inside the canister (Step S A64 (the execution condition B) to A66 in FIG. 4, time T51 to T54 in FIG. 23). If the user intends to refuel, the control unit prompts them to press the lid door switch (Step A66 in FIG. 4).

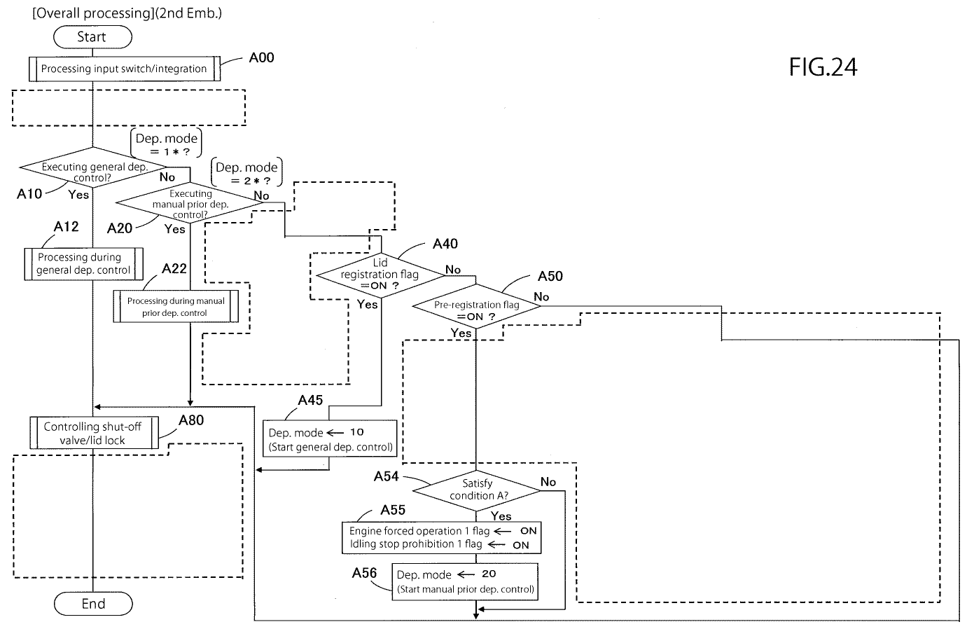

Next, a second embodiment of the present disclosure will be described with reference to FIGS. 24 to 32. The second embodiment differs from the first embodiment in that it includes a notification unit 31, but does not utilize the location information acquired by the location information acquisition unit (or does not include the location information acquisition unit). Therefore, processing related to the location of the vehicle and/or the location of the refueling facility is omitted. The processing and determinations enclosed by dotted lines in the flowcharts of the first embodiment are omitted. The “Controlling automatic prior depressurization” that is automatically executed when the vehicle enters the refueling facility is also omitted.

The [Overall processing] of the second embodiment shown in FIG. 24 omits the processing and determinations enclosed by dotted lines in the [Overall processing] shown in FIG. 4. The processing and determinations in each step in FIG. 24 have already been explained in FIG. 4, so they are omitted here. Additionally, in FIG. 24, the “Notification processing” at Step A02 in FIG. 4 is omitted, so the “Notification processing” in FIG. 6 is also omitted. Furthermore, the “Processing during automatic prior depressurization control” at Step A32 in FIG. 4 is omitted, so the “Processing during automatic prior depressurization control” in FIG. 10 is also omitted.

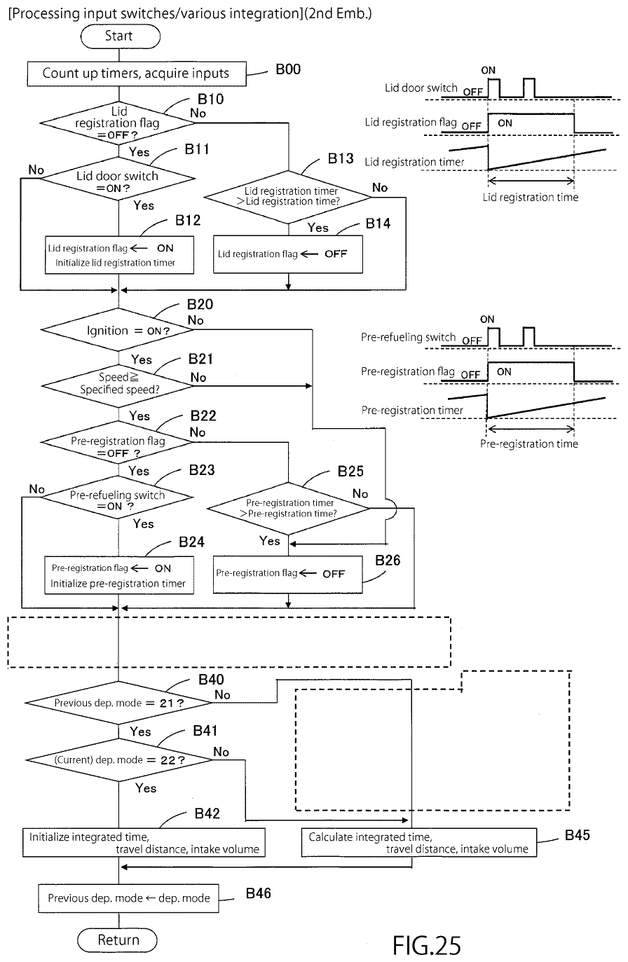

The [Processing input of switches/various integration] of the second embodiment shown in FIG. 25 omits the processing and determinations enclosed by dotted lines in the [Processing input of switches/various integration] shown in FIG. 5. The processing and determinations in each step in FIG. 25 are omitted since they have already been explained in FIG. 5.

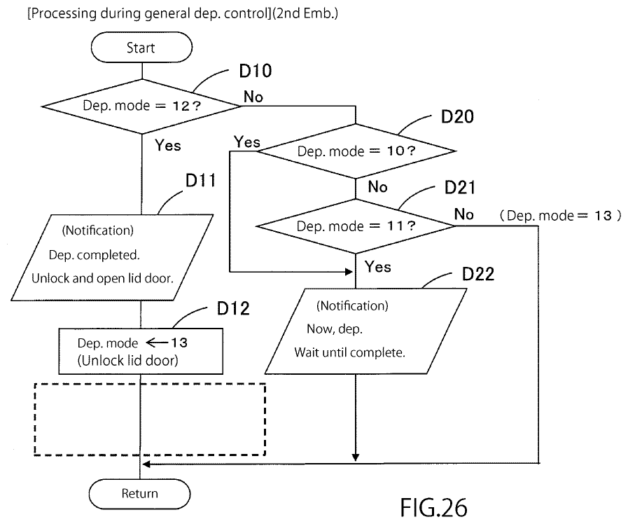

The [Processing during general depressurization control] of the second embodiment shown in FIG. 26 omits the processing and determinations enclosed by dotted lines in the [Processing during general depressurization control] shown in FIG. 7. The processing and determinations in each step in FIG. 26 are omitted because they have already been explained in FIG. 7.

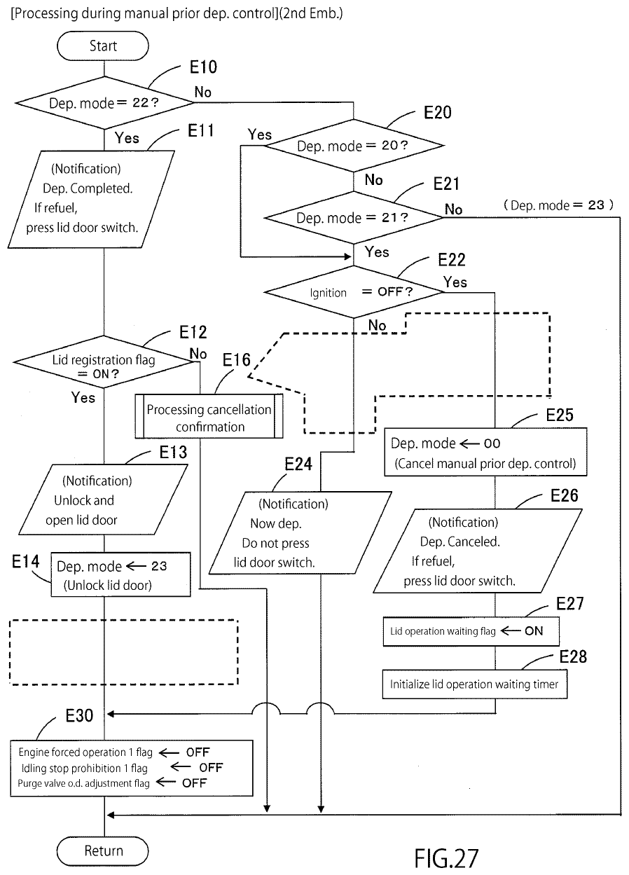

The [Processing during manual prior depressurization control] of the second embodiment shown in FIG. 27 omits the processing and determinations enclosed by dotted lines in the [Processing during manual prior depressurization control] shown in FIG. 8. The processing and determinations in each step in FIG. 27 are omitted because they have already been explained in FIG. 8.

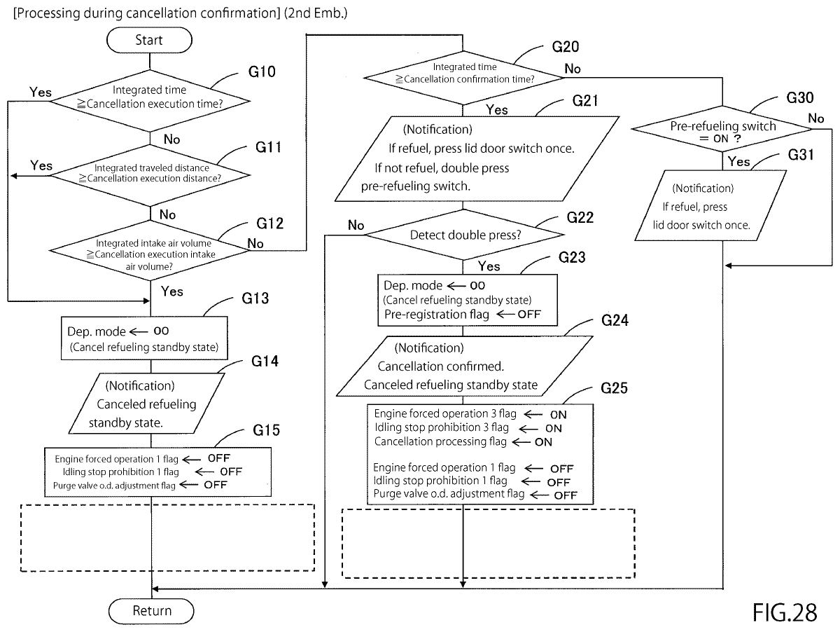

The [Processing during cancellation confirmation] of the second embodiment shown in FIG. 28 omits the processing and determination enclosed by the dotted line in the [Processing during cancellation confirmation] shown in FIG. 9. The processing and determination in each step in FIG. 28 are omitted because they have already been explained in FIG. 9.

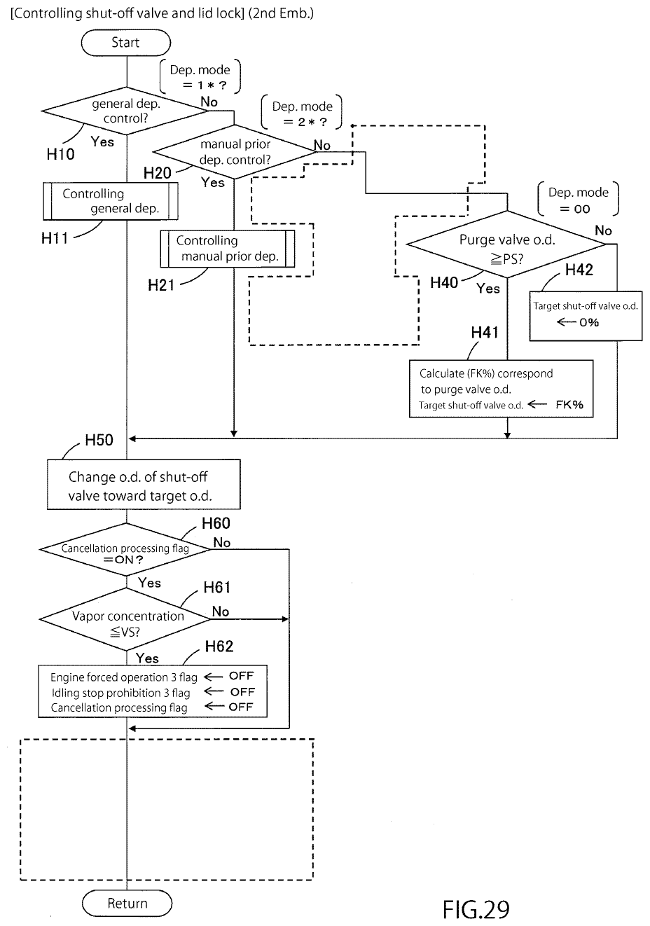

The [Controlling shut-off valve and lid lock] of the second embodiment shown in FIG. 29 omits the processing and determination enclosed by dotted lines in the [Controlling shut-off valve and lid lock] shown in FIG. 11. The processing and determination in each step in FIG. 29 are omitted because they have already been explained in FIG. 11. Additionally, in FIG. 29, the [Controlling automatic prior depressurization] of Step H31 in FIG. 11 is omitted, so the [Controlling automatic prior depressurization] in FIG. 17 is also omitted.

The [Controlling general depressurization] of the second embodiment is the same as the [Controlling general depressurization] in FIG. 12. The processing and determination of each step are omitted since they have already been explained in FIG. 12.

The [Controlling lid door lock] of the second embodiment is the same as the [Controlling lid door lock] in FIG. 13. The processing and determination of each step are omitted because they have already been explained in FIG. 13.

The [Controlling manual prior depressurization] of the second embodiment is the same as the [Controlling manual prior depressurization] shown in FIG. 14. The processing and determination of each step are omitted because they have already been explained in FIG. 14.

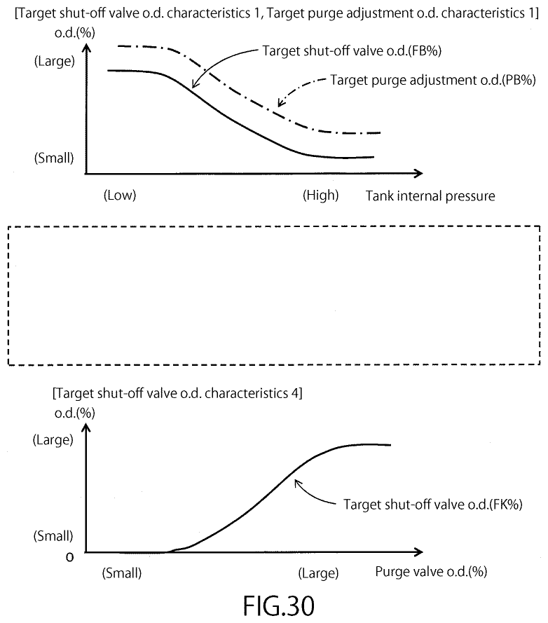

The [Target shut-off valve opening degree characteristics, Target purge adjustment opening degree characteristics] of the second embodiment shown in FIG. 30 is omitted the [Target shut-off valve opening degree characteristics 2, Target purge adjustment opening degree characteristics 2] and [Target shut-off valve opening degree characteristics 3, Target purge adjustment opening degree characteristics 3] enclosed by dotted lines in FIG. 15.

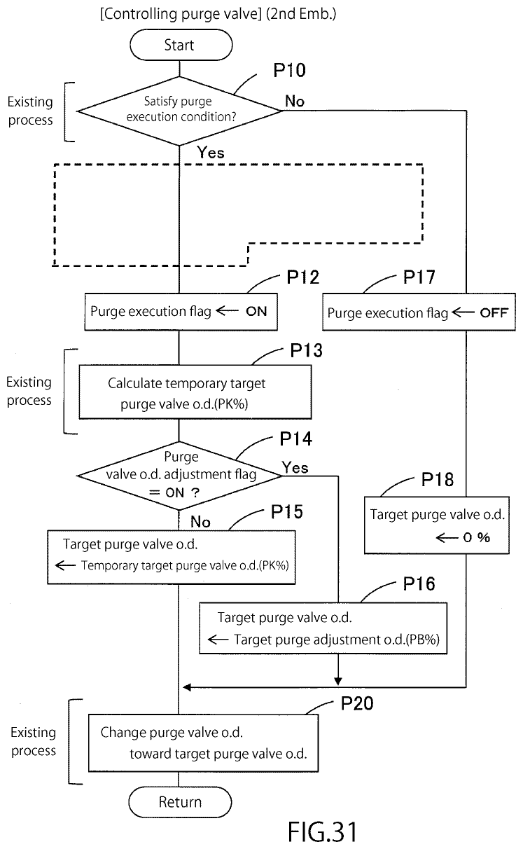

The [Controlling purge valve] of the second embodiment shown in FIG. 31 is omitted the processing and determinations enclosed by dotted lines in the [Controlling purge valve] shown in FIG. 16. The processing and determinations of each step in FIG. 31 are omitted because they have already been explained in FIG. 16.

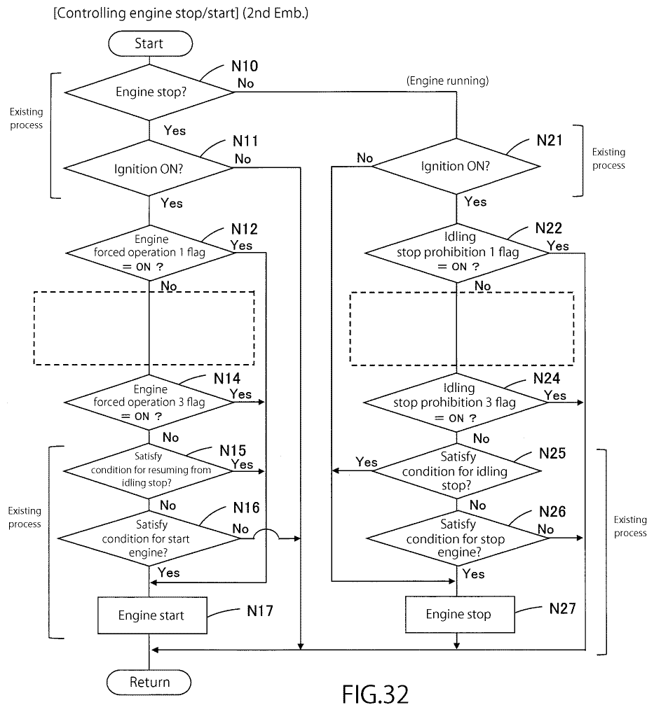

The [Controlling engine stop/start] of the second embodiment shown in FIG. 32 is omitted the processing and determinations enclosed by dotted lines in the [Controlling engine stop/start] shown in FIG. 18. The processing and determination of each step in FIG. 32 are omitted because they have already been explained in FIG. 18.

According to the sealed fuel tank system of the present disclosure, the depressurization in preparation for refueling is not automatically performed more than necessary, and the depressurization in preparation for refueling is performed while giving priority to whether the user intends to refuel. This reduces the waiting time when refueling, and prevents the remaining capacity of the canister for absorbing evaporated fuel from becoming less than necessary.

According to the first and second embodiments, if the user intends to refuel while driving near a refueling facility before arriving there, the user can start reducing the pressure inside the tank (the manual prior depressurization control) by operating the pre-refueling operation unit 42 (by pressing the pre-refueling switch) before operating the lid door operation unit 41. Upon arrival at the refueling facility, the depressurization is already complete. Therefore, the user can open the lid door and start refueling immediately by operating the lid door control unit 41 (by pressing the lid door switch), without having to wait for the depressurization to complete. Additionally, by operating the lid door control unit 41, the user can also execute the conventional general depressurization control.

According to the first embodiment, if the user enters a refueling facility without operating the refueling pre-operation unit 42 (and the lid door operation unit 41), automatic prior depressurization control is automatically started upon entering the refueling facility. Therefore, compared to the conventional case where the user stops the vehicle after entering the refueling facility and then presses the lid door switch to execute general depressurization control, the waiting time until depressurization is completed is further reduced.

In the second embodiment, even vehicles without a position information acquisition unit can execute manual prior depressurization control.

The sealed fuel tank system 1 disclosed in the present disclosure is not limited to the configuration, structure, appearance, shape, processing procedures, etc., described in the embodiments, and various changes, additions, and deletions may be made within the scope of the essence of the art disclosed herein. For example, each flowchart, each characteristic, and each motion waveform are not limited to those described in the embodiments.

In the present disclosure, an example is described where the lid door 50 and the surrounding structure have the structure shown in FIGS. 2 and 3. However, the lid door 50 and the surrounding structure are not limited to the structure shown in FIGS. 2 and 3. Furthermore, the method for determining whether the lid door 50 is open and the method for determining whether it is closed are not limited to the determination methods described in the present embodiment.

According to another aspect of the present disclosure, the sealed fuel tank system further comprises a notification unit. The control unit is configured to open the shut-off valve to reduce the fuel tank internal pressure when the pre-refueling operation unit is operated prior to the operation of the lid door operation unit, notify the user that the lid door operation unit can be operated and accept the operation of the lid door operation unit when the fuel tank internal pressure becomes lower than or equal to the specified pressure, and set the lid lock portion to the unlocked state when the control unit receives the operation of the lid door operation unit.

Therefore, after operating the pre-refueling operation unit prior to operating the lid door operation unit, the timing for operating the lid door operation unit is notified, enabling the user to easily determine the refueling timing (the timing to operate the lid door operation unit to open the lid door).

According to another aspect of the present disclosure, the sealed fuel tank system further comprises a position information acquisition unit configured to acquire a position of the vehicle and a position of a refueling facility, and a notification unit. The control unit is configured to notify the user of at least one of the following when the vehicle is within a specified range from the refueling facility: an operational status of the pre-refueling operation unit, a depressurization status of the fuel tank based on the operation of the pre-refueling operation unit, or whether the user intends to refuel.

Therefore, when the vehicle is within a specified range from the refueling facility, the operation status of the pre-refueling control unit (such as whether it is being operated), the depressurization status of the fuel tank (such as whether depressurization is being executed), and whether the user intends to refuel (such as “Please operate the pre-refueling operation unit if you intend to refuel”) are notified. This allows the system to prompt the user to operate the pre-refueling operation unit if the user intends to refuel but has forgotten to operate it.

According to another aspect of the present disclosure, the sealed fuel tank system further comprised a position information acquisition unit configured to acquire a position of the vehicle and a position of a refueling facility, and a notification unit. The control unit is configured to store a previously refueled facility position where the vehicle has previously refueled, and notify the user of at least one of the following when the vehicle is within a specified range from the previously refueled facility: an operational status of the pre-refueling operation unit, a depressurization status of the fuel tank based on the operation of the pre-refueling operation unit, or whether the user intends to refuel.

Therefore, by storing the position of the refueling facility where the user has refueled, the system can refrain from notifying the user when the user is near a refueling facility that the user has not used in the past, and can notify the user when the user is near the refueling facility that the user has used in the past. When notifying, the system indicates the operation status of the pre-refueling operation unit (such as whether it is being operated), the depressurize state of the fuel tank (such as whether depressurization is being executed), and whether the user intends to refuel (such as “Please operate the pre-refueling operation unite if you intend to refuel”) are notified. Therefore, for users who have decided on the specified refueling facility, unnecessary notifications are avoided, making the system convenient. Additionally, if the user forgets to operate the pre-refueling operation unit, the system can appropriately prompt the user to do so.

According to another aspect of the present disclosure, the sealed fuel tank system further comprises a position information acquisition unit configured to acquire a position of the vehicle, and a notification unit. The control unit is configured to store a pre-refueling operation history position, which is the position of the vehicle when the pre-refueling operation unit is operated prior to operation of the lid door operation unit, and notify the user of at least one of the following when the vehicle is within a specified range from the pre-refueling operation history position: an operational status of the pre-refueling operation unit, a depressurization status of the fuel tank based on the operation of the pre-refueling operation unit, or whether the user intends to refuel.

Therefore, by storing the position at which the user operated the pre-refueling operation unit, it is possible to notify the user when the user is within a specified range from the position where the user previously executed the pre-refueling operation unit. When notifying, the system indicates the operation status of the pre-refueling operation unit (such as whether it is being operated), the depressurization status of the fuel tank (such as whether depressurization is being executed), and whether the user intends to fuel (such as “Please operate the pre-refueling operation unite if you intend to refuel”). Therefore, the system is convenient because unnecessary notifications are avoided. Additionally, if the user forgets to operate the pre-refueling operation unit, the system can appropriately prompt the user to do so.

According to another aspect of the present disclosure, the sealed fuel tank system further comprises a position information acquisition unit configured to acquire a position of the vehicle and a position of a refueling facility. The control unit is configured to adjust an opening degree of the shut-off valve in accordance with a distance between the vehicle and the refueling facility when the pre-refueling operation unit is operated prior to operation of the lid door operation unit.

Therefore, by adjusting the opening degree of the shut-off valve in accordance with the distance from the vehicle to the refueling facility, unnecessary power consumption and aging of the shut-off valve are suppressed, and the tank internal pressure can be reduced to a predetermined pressure at an appropriate timing (e.g., just before arriving at the refueling facility). Thus, the user can open the lid door immediately upon arriving at the refueling facility by operating the lid door control unit, without any waiting time.

According to another aspect of the present disclosure, the sealed fuel tank system further comprises a position information acquisition unit configured to acquire a position of the vehicle and a position of a refueling facility. The control unit is configured to estimate a required time for the vehicle to reach the refueling facility, and adjust an opening degree of the shut-off valve in accordance with the estimated required time when the pre-refueling operation unit is operated prior to operation of the lid door operation unit.

Therefore, by adjusting the opening degree of the shut-off valve in accordance with the arrival time required for the vehicle to reach the refueling facility, unnecessary power consumption and aging deterioration of the shut-off valve are suppressed, and the fuel tank internal pressure can be reduced to a specified pressure at an appropriate timing (e.g., just before arriving at the refueling facility). Thus, the user can open the lid door immediately upon arriving at the refueling facility by operating the lid door control unit, without any waiting time.

According to another aspect of the present disclosure, the control unit is configured to adjust an opening degree of the shut-off valve in accordance with the internal pressure of the fuel tank when the pre-refueling operation unit is operated prior to operation of the lid door operation unit.

Therefore, adjusting the opening degree of the shut-off valve in accordance with the tank internal pressure suppresses unnecessary power consumption and aging deterioration of the shut-off valve.

According to another aspect of the present disclosure, the sealed fuel tank system further comprises a position information acquisition unit configured to acquire a position of the vehicle and a position of a refueling facility. The control unit is configured to close the purge valve and open the shut-off valve to start depressurization of the internal pressure of the fuel tank when the vehicle enters the refueling facility while both the pre-refueling operation unit and the lid door operation unit are not being operated.

Therefore, if the user enters the refueling facility without operating the pre-refueling operation unit, the system automatically starts reducing the tank internal pressure, thereby shortening the waiting time until the lid door opens.

According to another aspect of the present disclosure, the sealed fuel tank system wherein, when the pre-refueling operation unit is operated prior to operation of the lid door operation unit, and the shut-off valve is opened to depressurize the internal pressure of the fuel tank, the control unit is configured to start the internal combustion engine to bring it into operation if the internal combustion engine of the vehicle is in a stopped state, prohibit operation of an idling stop function if the vehicle has an idling stop function, and execute purge control to open the purge valve and depressurize the internal pressure of the fuel tank.

Therefore, when the tank internal pressure is reduced by operating the pre-refueling operation unit by the user, the shut-off valve is opened to guide the evaporated fuel in the fuel tank to the canister. If the purge control is not executed, the amount of evaporated fuel accumulated in the canister will increase. To avoid this, if the internal combustion engine is in a stopped state, it is switched to an operating state, and if it has an idling stop function, the operation of the idling stop function is prohibited, forcing the internal combustion engine to operate and executing purge control to open the purge valve. Thus, by executing purge control when reducing the tank internal pressure through operation of the pre-refueling operation unit, it is possible to prevent an increase in the amount of evaporated fuel accumulated in the canister.

According to another aspect of the present disclosure, the control unit is configured to cancel a refueling standby state if the lid door operation unit is not operated even after the vehicle's driving state reaches a specified state following transition to the refueling standby state. The refueling standby state being a state in which the pre-refueling operation unit is operated prior to operation of the lid door operation unit to open the shut-off valve and reduce the internal pressure of the fuel tank to lower than or equal to the specified pressure, and the system is waiting for operation of the lid door operation unit.

Therefore, even if the tank internal pressure is reduced to a specified pressure or below by operating the pre-refueling operation unit prior to operating the lid door operation unit, and the system transitions to the refueling standby state and waits for the user to operate the lid door operation unit, there may be cases where the user does not operate the lid door operation unit. For example, the user may have operated the pre-refueling operation unit with the intention of refueling, but due to some reason, the vehicle continues to drive without stopping at the refueling facility before arriving there. After transitioning to the refueling standby state, even if the vehicle's operating condition reaches the specified operating condition (e.g., the driving time exceeds the specified driving time), if the lid door control unit is not operated, the refueling standby state is canceled, and the system returns to the state prior to the operation of the pre-refueling operation unit, thereby restoring the sealed fuel tank system to a state without refueling intent.

The various examples described above in detail with reference to the attached drawings are intended to be representative of the present disclosure and are thus non-limiting embodiments. The detailed description is intended to teach a person of skill in the art to make, use and/or practice various aspects of the present teachings, and thus does not limit the scope of the disclosure in any manner. Furthermore, each of the additional features and teachings disclosed above may be applied and/or used separately or with other features and teachings in any combination thereof, to provide an improved sealed fuel tank system, and/or methods of making and using the same.

What is claimed is:

1. A sealed fuel tank system comprising:
a fuel tank of a vehicle equipped with an internal combustion engine;
a canister configured to adsorb and desorb fuel evaporated inside the fuel tank;
a vapor passage connecting the fuel tank and the canister;
a purge passage connecting the canister and an intake passage of the internal combustion engine;
a shut-off valve disposed in the vapor passage and configured to seal the fuel tank;
a purge valve configured to open and close the purge passage;
a tank pressure detection unit configured to detect internal pressure of the fuel tank;
a lid door operation unit configured to unlock a lid door;
a lid lock portion;
a control unit implemented by at least one programmed processor and configured to control the purge valve, the shut-off valve, and the lid lock portion; and
a pre-refueling operation unit,
wherein the lid lock portion is configured to lock and unlock the lid door covering a fuel tank opening, and unlock the lid door when the lid door operation unit is operated by a user and the internal pressure of the fuel tank is less than or equal to a specified pressure, and
wherein the pre-refueling operation unit is configured to open the shut-off valve to reduce the internal pressure of the fuel tank to less than or equal to the specified pressure when operated prior to operation of the lid door operation unit.

2. The sealed fuel tank system according to claim 1, further comprising a notification unit, wherein the control unit is configured to:
open the shut-off valve to release the internal pressure of the fuel tank when the pre-refueling operation unit is operated prior to operation of the lid door operation unit;
notify the user that the lid door operation unit can be operated when the internal pressure of the fuel tank becomes less than or equal to the specified pressure;
accept the operation of the lid door operation unit; and
set the lid lock portion to an unlocked state when the control unit receives the operation of the lid door operation unit.

3. The sealed fuel tank system according to claim 1, further comprising:
a position information acquisition unit configured to acquire a position of the vehicle and a position of a refueling facility; and
a notification unit,
wherein the control unit is configured to notify the user of at least one of the following when the vehicle is within a specified range from the refueling facility:
(i) an operational status of the pre-refueling operation unit,
(ii) a depressurization status of the fuel tank based on the operation of the pre-refueling operation unit, or
(iii) whether the user intends to refuel.

4. The sealed fuel tank system according to claim 1, further comprising:
a position information acquisition unit configured to acquire a position of the vehicle and a position of a refueling facility; and
a notification unit,
wherein the control unit is configured to store a previously refueled facility position where the vehicle has previously refueled, and notify the user of at least one of the following when the vehicle is within a specified range from the previously refueled facility:
(i) an operational status of the pre-refueling operation unit,
(ii) a depressurization status of the fuel tank based on the operation of the pre-refueling operation unit, or
(iii) whether the user intends to refuel.

5. The sealed fuel tank system according to claim 1, further comprising:
a position information acquisition unit configured to acquire a position of the vehicle; and
a notification unit,
wherein the control unit is configured to store a pre-refueling operation history position of the vehicle, when the pre-refueling operation unit is operated prior to operation of the lid door operation unit, and
notify the user of at least one of the following, when the vehicle is within a specified range from the pre-refueling operation history position:
(i) an operational status of the pre-refueling operation unit,
(ii) a depressurization status of the fuel tank based on the operation of the pre-refueling operation unit, or
(iii) whether the user intends to refuel.

6. The sealed fuel tank system according to claim 1, further comprising a position information acquisition unit configured to acquire a position of the vehicle and a position of a refueling facility, wherein the control unit is configured to adjust an opening degree of the shut-off valve in accordance with a distance between the vehicle and the refueling facility when the pre-refueling operation unit is operated prior to operation of the lid door operation unit.

7. The sealed fuel tank system according to claim 1, further comprising a position information acquisition unit configured to acquire a position of the vehicle and a position of a refueling facility,
wherein the control unit is configured to estimate a required time for the vehicle to reach the refueling facility, and adjust an opening degree of the shut-off valve in accordance with the estimated required time when the pre-refueling operation unit is operated prior to operation of the lid door operation unit.

8. The sealed fuel tank system according to claim 1, wherein the control unit is configured to adjust an opening degree of the shut-off valve in accordance with the internal pressure of the fuel tank when the pre-refueling operation unit is operated prior to operation of the lid door operation unit.

9. The sealed fuel tank system according to claim 1, further comprising a position information acquisition unit configured to acquire a position of the vehicle and a position of a refueling facility,
wherein the control unit is configured to close the purge valve and open the shut-off valve to start depressurization of the internal pressure of the fuel tank when the vehicle enters the refueling facility while both the pre-refueling operation unit and the lid door operation unit are not being operated.

10. The sealed fuel tank system according to claim 1, wherein when the pre-refueling operation unit is operated prior to operation of the lid door operation unit, and the shut-off valve is opened to depressurize the internal pressure of the fuel tank, the control unit is configured to start the internal combustion engine to bring it into operation if the internal combustion engine of the vehicle is in a stopped state, prohibit operation of an idling stop function if the vehicle has an idling stop function, and execute purge control to open the purge valve and depressurize the internal pressure of the fuel tank.

11. The sealed fuel tank system according to any one of claims 1 to 10, wherein the control unit is configured to cancel a refueling standby state if the lid door operation unit is not operated even after the vehicle's driving state reaches a specified state subsequent to transition to the refueling standby state, the refueling standby state being a state in which the pre-refueling operation unit is operated prior to operation of the lid door operation unit to open the shut-off valve and release the internal pressure of the fuel tank to less than or equal to the specified pressure, and the system is waiting for operation of the lid door operation unit.
